(19) United States
(12) Patent Application Publication
(10) Pub. No.: US 2009/0162515 A1
(43) Pub. Date: Jun. 25, 2009

(54) Method of Preparation of Adapted Foods

(75) Inventors: Therese Dufresne, Montreal (CA); Isabelle Germain, Pincourt (CA)

Correspondence Address: DAVID S. RESNICK, NIXON PEABODY LLP, 100 SUMMER STREET, BOSTON, MA, 02110-2131, US

(73) Assignee: SA MAJESTE LA REINE DU CHEF DU CANADA, Sainte-Anne de Bellevue (CA)

(21) Appl. No.: 12/339,185

(22) Filed: Dec. 19, 2008

Related U.S. Application Data
(63) Continuation of application No. 10/495,747, filed on May 27, 2004, now abandoned.
(60) Provisional application No. 60/341,880, filed on Dec. 21, 2001.

(51) Int. Cl. A23L 1/05

(52) U.S. Cl. 426/573

(57) ABSTRACT

The present invention relates to a method of preparing adapted foods where the composition allows the facilitation of the acts of eating or drinking for dysphagic patients. The method comprises modulating the parameters of the rheological profile, consisting of firmness, cohesiveness, springiness, gumminess, chewiness and consistency. The adapted food composition has also physical characteristics conferring aspects at serving, flavors, aromas, and temperature of an equivalent non-transformed counterpart.

### CROSS-REFERENCE TO RELATED APPLICATIONS

This application is a Continuation Application which claims benefit under 35 U.S.C. § 120 of U.S. application Ser. No. 10/495,747 filed May 24, 2004, which is a 371 National Entry of Canadian International Application No. PCT/CA02/01970 filed Dec. 19, 2002, which designated the U.S. and which claims benefit under 35 U.S.C. § 119(e) from U.S. Provisional Application 60/341,880 filed Dec. 21, 2001.

### FIELD OF THE INVENTION

The present invention relates to the rheological profile of foods facilitating the act of deglutition in people suffering of dysphagia. Measurement ranges of rheological parameters of food substances, solid or liquid, are determined to overcome the difficulties associated with the dysphagia.

### BACKGROUND OF THE INVENTION

Dysphagia is the inability to swallow or difficulty in swallowing and may be caused by stroke, neuro-degenerative diseases, or respiratory disorders. Swallowing is a complicated action which is usually initiated voluntarily and is generally completed reflexively, whereby food is moved from the mouth through the pharynx and esophagus to the stomach. The act of swallowing occurs in three stages and requires the integrated action of the respiratory center and motor functions of multiple cranial nerves, and the coordination of the autonomic system within the esophagus.

In the first stage, food is placed on the surface of the tongue. The tip of the tongue is placed against the hard palate. Elevation of the larynx and backward movement of the tongue forces the food through the isthmus of the fauces in the pharynx. In the second stage, the food passes through the pharynx. This involves constriction of the walls of the pharynx, backward bending of the epiglottis, and an upward and forward movement of the larynx and trachea. Food is kept from entering the nasal cavity by elevation of the soft palate and from entering the larynx by closure of the glottis and backward inclination of the epiglottis. During this stage, respiratory movements are inhibited by reflex. In the third stage, food moves down the esophagus and into the stomach. This movement is accomplished by momentum from the second stage, peristaltic contractions, and gravity. Although the main function of swallowing is the propulsion of food from the mouth into the stomach, swallowing also serves as a protective reflex for the upper respiratory tract by removing particles trapped in the nasopharynx and oropharynx, returning materials refluxed from the stomach into the pharynx, or removing particles propelled from the upper respiratory tract into the pharynx. Therefore, the absence of adequate swallowing reflex greatly increases the chance of pulmonary aspiration.

In the past, patients suffering from dysphagia have undergone dietary changes or thermal stimulation treatment to regain adequate swallowing reflexes. Thermal stimulation involves immersing a mirror or probe in ice or cold substance. The tonsillar fossa is stimulated with the mirror or probe and the patient closes his mouth and attempts to swallow. While these traditional methods are usually effective for treating dysphagia, these methods often require that the patient endure weeks or months of therapy.

Electrical stimulation has often been used as a method for alleviating pain, stimulating nerves, and as a means for diagnosing disorders of the spinal cord or peripheral nervous system. Electrical stimulation has further been used to facilitate muscle reeducation and with other physical therapy treatments. In the past, electrical stimulation was not recommended for use in the neck or thoracic region as severe spasms of the laryngeal and pharyngeal muscles may occur resulting in closure of the airway or difficulty in breathing. Further, the introduction of electrical current into the heart may cause cardiac arrhythmia.

Electrical stimulation has been used to stimulate the recurrent laryngeal nerve to stimulate the laryngeal muscles to control the opening of the vocal cords to overcome vocal cord paralysis, to assist with the assessment of vocal cord function, to aid with intubation, and other related uses. However, heretofore, electrical stimulation has not been used in the treatment of dysphagia to promote the swallowing reflex which involves the integrated action of the respiratory center and motor functions of multiple cranial nerves, and the coordination of the autonomic system within the esophagus.

Dysphagia is a well-recognized condition and has been studied and addressed by doctors and nutritionists. Such studies have noted that the condition is affected by the temperature, pH, viscosity, volume, size and shape of particulate matter in the ingested sample, and that these conditions can affect the likelihood of a bolus passing safely through the swallowing process.

When an individual experiences problems swallowing thin liquids, the increase in fluid thickness is often required for a safe swallow of beverages in the treatment of dysphagia. This generally helps in reducing the seepage of the liquid from the mouth or by decreasing the speed at which the liquid will pass from the mouth to the pharynx to the esophagus. The liquids are generally described with 3 illustrative terms: Nectar-like products, Honey-like products, pudding or spoon-thick products. The thickened beverages could be prepared for the patient by the staff and family members or they could be purchased. When prepared for the patient, the use of commercial thickeners and other thickening agents such as baby cereals is fairly common. The palatability, the consistency and the costs of the resulting thickened beverages can differ greatly.

A commercial thickener cornstarch was used to thicken tap water according to what speech-language pathologists (SLPs) believed to be Nectar, Honey and Pudding consistency liquids. The SLPs were asked to repeat the experiment 3 times with a 2-4 minute break between each set of consistencies. The Nectar and Honey products were evaluated for their viscosity using a Brookfield viscometer (cone/plate model, LVDV II). No correlation was found for the intersubject results (R=−0.03 for Honey; R=+0.02 for Nectar) and intrasubject correlation was weak (R=+0.67 for Honey; R=+0.33 for Nectar). The authors have concluded that subjective judgment is not a valid method in the treatment of dysphagia and suggest that a standardized method for mixing consistencies be adopted.

The modification of the texture of the solids is often suggested to facilitate bolus formation and swallow. The diet requirements will be expressed as soft, minced or pureed foods. The desired texture is usually obtained with a blender or a food processor. The addition of a liquid is frequently required to produce a pureed product that is smooth and without lumps or big particles. However this dilution technique is thought to reduce the nutrient density. The resulting products have been qualified by many as not appealing and bland. Special efforts should be made to improve the taste and the appearance. Once more, the description of the texture modified diets is usually qualitative. A number of cookbooks have been published to help in the realization of adapted foods for dysphagic individuals.

Consequently, the dysphagia diets usually take the form of forbidden or allowed foods. They use descriptive terms such as sticky, smooth, soft or homogeneous to discuss the foods that are permitted or forbidden. This list of terms creates an interpretation dilemma in the clinical management of the diets offered to the dysphagic patients. Clinical trials evaluating specifically the efficacy of the various dysphagia diets and quantification of the textural parameters of a nutritious minced or pureed diet have not yet been published.

All of the dysphagia diets published are mainly based on a descriptive evaluation of the consistency of solids and liquids and very little is said about nutritional efficacy or quantitative textural characteristics of the foods permitted for the patients. The dysphagia diets usually take the form of forbidden and allowed foods and are qualitative in their descriptions of what is acceptable versus what is not. Many professionals such as doctors, nurses, radiologists, speech-language pathologists, occupational therapists, physiotherapists and dietitians may be required to participate in the clinical evaluation of the dysphagic individual. The multidisciplinary approach required for the treatment of dysphagia necessitates communication and coordination. It is essential to insure that what is clinically observed as problem during the evaluation of the patient is what is conveyed via the dietetic prescription. It is believed that dysphagic individuals able to handle specific test material during clinical evaluations such as videofluoroscopy should be able to swallow foods of similar texture. Thereafter, a qualitative description of the appropriate foods will be given and a subjective evaluation of what the prescribed diet should be is done. A lack of objectivity in the transmission of the clinical information could lead to clinical errors.

Although treatment and diagnosis of dysphagia have been addressed, there is little standardization within the medical profession for treating the conditions related to dysphagia.

It would be highly desirable to be provided with a new adapted food composition and method of preparing it for facilitating, and even for stimulating, the swallowing functions of a dysphagic patient.

### SUMMARY OF THE INVENTION

One object of the present invention is to provide a method for preparing an adapted food composition for facilitating the act of swallowing in dysphagic patients, the method comprising the steps of:

a) transforming a food substance to give a modified food substance and allowing the incorporation of at least one binding and/or gelling and/or thickening compound capable to modulate the rheological profile of the transformed food substance;

b) adding at least one binding and/or gelling and/or thickening compound for modulating the rheological profile of the transformed food substance to give an adapted food composition; and

c) causing serving rheological profile and physical characteristics to the adapted food composition of step b) in the form of its equivalent non-transformed food counter-part.

wherein the rheological profile or the serving rheological profile consists in a combination of rheological parameters defined as firmness, cohesiveness, springiness, adhesiveness, gumminess, chewiness and consistency.

The food substance may be a solid or liquid food.

Swallowing is the transit of food substance from lips to stomach of the dysphagic patient (FIGS. 1a & 1b). “Dysphagia” is a swallowing impairment and may occur during the acts of mastication, bolus formation, bolus transfer and bolus swallowing, or a combination thereof. “Dysphagia” may be used interchangeably with swallowing disorder or deglutition disorder.

The transforming of a food substance may be crunching, grinding, chopping, pureeing, mixing, blending, stirring, warming, heating, cooking, cooling, refrigerating, freezing, rethermalizing, diluting, modifying the particle size or creating a new macro-structure within the adapted food of the food substance.

The HSA Nectar liquid may have a consistency of between 13 to 15 cm per 30 seconds, the HSA Honey liquid may have a consistency of between 7 to 9 cm per 30 seconds, and the HSA Pudding liquid may have a consistency of between 3 to 5 cm per 30 seconds.

The food substance of the present invention may be selected from the group consisting of a pureed meat, fish, poultry, vegetable, fruit, baked good, pastry, egg, dairy product or a combination of two or more.

Also, the serving rheological profile of an adapted food composition prepared with a ground meat as food substance may consist in combination of firmness between about 1.007 to 11.086 Newton, cohesiveness between about 0.105 to 0.388, springiness between about 1.324 to 24.416%, and adhesiveness between about −0.199 to −1.212 mm, gumminess between about 0.205 and 3.776 Newton, chewiness between about 0.410 to 28.607 Newton.

The rheological profile of an adapted food composition prepared with a pureed food substance of meat, fish, poultry, vegetable, fruit, baked good, dairy product or a combination of two or more can consist in combination of firmness between about 0.385 to 7.202 Newton, cohesiveness between about 0.095 to 0.590 springiness between about 0.980 to 62.505%, and adhesiveness between about −0.148 to −1.601 Newton, gumminess between about 0.064 and 3.729 Newton, chewiness between about 0.095 to 197.513 Newton.

Also, the binding and/or gelling and/or thickening compound may be selected from the group consisting of proteins, carrageenans, starches, gums, gelatins, and/or any other and/or binding and/or gelling and/or thickening agent.

The physical characteristic may be selected from the group consisting of a flavor, a visual appearance, a physical aspect, a color, a temperature, and an aroma, and the modulation of the rheological profile may also be reducing or increasing at least one rheological parameter, and may be modulated to allow the adapted food composition to have a serving rheological profile after cooling, refrigerating, freezing, thawing, heating or warming.

Another object of the present invention is to provide an adapted food composition produced by the method as mentioned earlier is for the facilitation of the act of swallowing for dysphagic patients.

For the purpose of the present invention the following terms are defined below.

The term “facilitate” and “facilitation”, are used herein to mean the compensation for an impaired functioning of the acts of mastication, bolus formation, bolus transfer and bolus swallowing or a combination thereof.

The term “firmness” as used herein is intended to mean the force required to obtain a deformation of a body. The ‘firmness’ measurement units is expressed here in Newton. A Newton is a unit of force equal to the force that produces an acceleration of one meter per squared second of a mass of one kilogram. The terms firmness and hardness can be used interchangeably.

The term “cohesiveness” as used herein is intended to mean the strength of the internal bonds making up the body of the food. It can be defined as the molecular force between particles within a body or substance that acts to unite them. Cohesiveness is a ratio of two firmness measurements. Therefore, it has no units.

Consistency is an empirical measurement of the flow of a liquid for a given time at a given temperature. The measure of consistency is presented here as centimeters per 30 seconds.

The term “springiness” as used herein is intended to mean the rate at which deformed foods go back to their original undeformed state after removal of the force. The measurement unit of springiness is expressed here in percentage. The springiness is the property of a substance that enables it to change its length, volume, or shape in direct response to a force effecting such a change and to recover its original form upon the removal of the force. The terms springiness and elasticity can be used interchangeably.

The term “adhesiveness” as used herein is intended to mean the force necessary to overcome the attractive forces between the surface of a matter and the surface of an other material with which it is in contact. The adhesiveness is the attractive molecular force that tends to hold together unlike bodies when they are in contact. The measurement unit of adhesiveness is expressed here in mm.

The acronym TPA stands for texture profile analysis and is composed of one or more rheological parameters described above.

Other acronyms:

SAH stands for St. Anne's Hospital

BMI means body mass index and is expressed in kilogram per squared meter.

### BRIEF DESCRIPTION OF THE DRAWINGS

FIGS. 1a and 1b illustrate dysphagia and dysphagia in the elderly respectively;

FIG. 2 illustrates typical flow curves of Newtonian and non-Newtonian fluids;

FIG. 3 illustrates a typical texture profile analysis;

FIGS. 4A and 4B illustrate a typical shear stress of thickened cranberry juice as affected by shear rate and time (4A) and a typical shear stress of thickened vanilla supplement as affected by shear stress and time (4B);

FIGS. 5A to 5F illustrate rheograms of thickened cranberry and orange juices of nectar consistency at 8° C. (5A), of honey consistency at 8° C. (5B), of pudding consistency at 8° C. (5C), and rheograms of thickened milk and vanilla supplement of nectar consistency at 8° C. (5D), of honey consistency at 8° C. (5E), and of pudding consistency at 8° C. (5F);

FIG. 6 illustrates the apparent viscosity of the cold thickened beverages offered at SAH;

FIGS. 7A to 7D illustrate a correlation between consistency coefficient and consistency grouping (7A), the correlation between apparent viscosity and consistency (7B), the correlation between flow behavior index and consistency grouping (7C), and the correlation between yield stress and consistency grouping (7D);

FIGS. 8A to 8D illustrates a typical texture profile analysis of the minced beef slices at 65° C. (8A), pureed beef slices at 65° C. (8B), pureed asparagus at 65° C., and pureed apple cake at 8° C.;

FIG. 9 illustrates the selection of subjects;

FIG. 10 illustrates an average weight at each time point for both groups during the protocol;

FIG. 11 illustrates an average BMI at each time point for both groups during the protocol;

FIG. 12 illustrates the evolution of the weight of each individual in the control group during the protocol;

FIG. 13 illustrates the evolution of the weight of each individual in the treated group during the protocol;

FIG. 14 illustrates the weight change of the control group over time;

FIG. 15 illustrates the weight change of the treated group over time; and

FIG. 16 illustrates the aspect of different foods after processing.

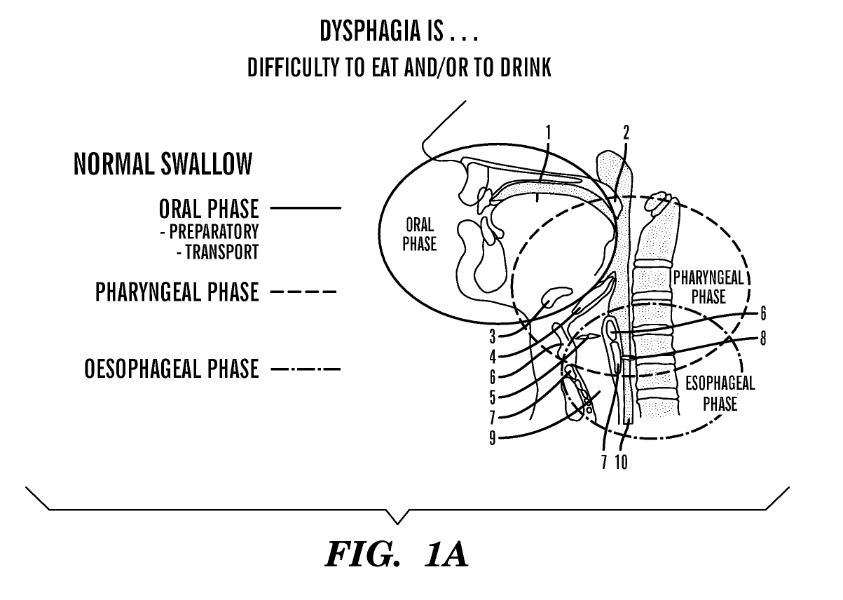

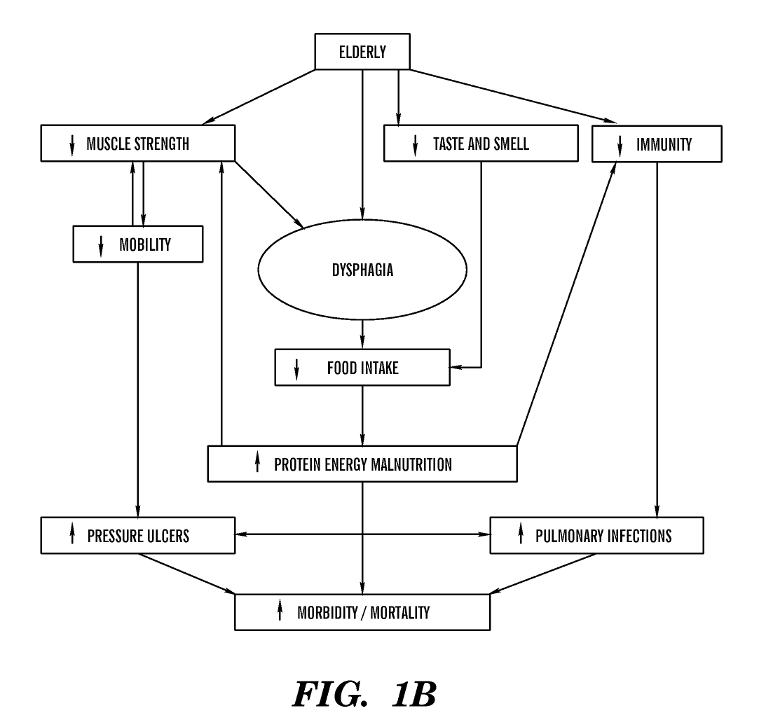

### DETAILED DESCRIPTION OF THE INVENTION

In accordance with the present invention, there is provided a method allowing to transform a solid or liquid food substance into a food composition adapted to facilitate the act of swallowing for dysphagic patients.

In one embodiment of the present invention, one step of the method invention comprises the modulation of at least one parameter of a food's rheological profile in a manner to allow the food composition at serving to have a desired firmness, springiness, cohesiveness, gumminess, chewiness, consistency.

According to another embodiment of the invention, there is provided a method in which a quantitative and descriptive approach is used to adapt the food texture in the clinical management of dysphagia. A description of textural characteristics of foods is provided and is prone to be an integral part of the clinical management of dysphagia. No publication has reported quantified food texture in relation to its importance in the health care of dysphagic individuals. Rheology is now offering a promising avenue in a more objective treatment of dysphagia.

Rheology is the study of the deformation and flow of foods. It offers vocabulary and specific terminology to discuss foods and their textural characteristics. Foods vary greatly in composition and show a vast array of textural characteristics. Liquids could be viscous and thick like molasses or fluid and thin like water. They could be suspensions like salad dressings or pure solutions like salty water. Solids also vary in texture. Crackers and baked pie crust could be brittle and dry. Foods could be hard like Parmesan cheese or soft like Ricotta. Solids could be adhesive like peanut butter or slippery like butter and margarine. Rheology also offers several instruments such as viscometers and texturometers which permit quantification of these textural characteristics.

### Rheology of Liquids

Viscosity is the internal friction of a fluid or its resistance to flow. The rate of flow per unit of force due to viscosity is milli-Pascal-seconds (mPa·s) or centipoises (cPs). Viscosity is a textural parameter that could be evaluated by fundamental testing which quantifies the flow of fluids. Instrumental devises such as capillary flow, Couette or Searle flow, parallel-plate or cone-and-plate viscometers could be used to determine viscosity. Isaac Newton was the first to express the law of ideal liquids. The following formula can best describe the flow behavior of ideal liquids as

η=σ/γ (Equation 1)

where η is the viscosity (Pa·s), σ is the shear stress (Pa) and, γ is the shear rate (s⁻¹).

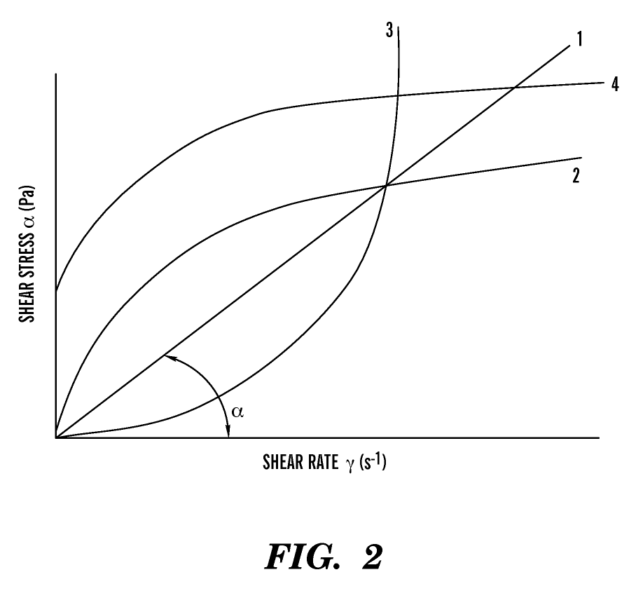

Ever since, fluids are mainly classified as Newtonian or non-Newtonian. A linear relationship of the shear stress (σ) expressed in Pascal as a function of shear rate (γ) expressed in s⁻¹ illustrates the flow behavior of ideal liquids (FIG. 2). A Newtonian liquid will have a constant slope that will express viscosity (η). The Newtonian liquids present flow characteristics that are influenced only by temperature and food composition. The Newtonian foods are not affected by shear rate and shear history. Typical Newtonian foods are egg products, most honeys, corn syrups and milk.

Non-Newtonian liquids are affected by temperature, food composition and shear rate. The apparent viscosity (ηₐ) is then used to express the viscosity and is specific to the shear rate at which the product is tested. Non-Newtonian foods could further be divided as time-independent or time-dependent. The latter, contrary to time-independent fluids, will show an apparent viscosity that will be affected by the length of time for which the shear is applied. Time-independent fluids could be either pseudoplastic (i.e. shear-thinning, losing viscosity with time at a varying shear rate) or dilatant (i.e. shear-thickening, gaining viscosity over time) which is rarely encountered. Shear-thinning could be explained by re-orientation, stretching, deformation or disaggregation of molecules, which compose the tested product, following shear. Therefore, important decrease in viscosity could be observed in products after the shearing. Some pseudoplastic foods are concentrated fruit juices, french mustard and fruit and vegetable purees.

Time-dependent flow characteristics are further divided into thixotropic and rheopectic liquids. The former displays a decrease in viscosity when a constant shear rate is applied for a certain period of time.

The latter presents an increase in viscosity over time when the shear rate is maintained constant. Examples of thixotropic foods are mayonnaise and condensed milk. Rheopectic foods have never been reported.

Most foods do not follow the ideal liquid law expressed by Newton. Time-independent type of fluids have been described according to different rheological models. The Power Law (Equation 2) and the Herschel-Bulkley models (Equation 3) are most often used in the literature to describe the rheological parameters of foods. The Herschel-Bulkley model was developed to mathematically express products for which a yield stress (σₒ) is found at the initial application of the shear rate. Therefore, the product will act similar to a solid: it will require a certain level of shear prior to beginning its deformation.

σ=μγ^{v} (Equation 2)

σ−σₒ=μγ^{v} (Equation 3)

where σₒ=yield stress factor.

The Casson model is also used when describing flow behavior of foods and was chosen as the official method for the interpretation of chocolate flow data by the International Office of Cocoa and Chocolate (Equation 4).

σ^{0.5}−μₒ=μγ^{0.5} (Equation 4)

These models relate shear stress and shear rate in conjunction with the specific flow behavior index (n), consistency coefficient (m) and yield stress factor (σₒ). The flow behavior index will be equal to 1 for Newtonian liquids, greater than 1 for shear-thickening foods and less than 1 for shear-thinning non-Newtonian fluids. The yield stress factor will be 0 for Newtonian fluids. The consistency coefficient will be greater than 0 and will vary according to the product.

The Bingham model was used to describe the flow behavior of apricot puree and minced fish paste (Equation 5). It expresses the plastic viscosity (η′).

σ−σₒ=η′γ (Equation 5)

This model is applicable when shear-thinning products are evaluated at medium to high shear rate. At low shear rate, the shear-thinning fluids will demonstrate a Newtonian behavior (zero shear viscosity) and the Power Law model will not be able to evaluate the viscosity. Other models have been developed to overcome this problem. They are the Cross model (Equation 6) and the Powell-Eyring model (Equation 7) where η is the apparent viscosity, η₀ is the limiting viscosity at zero rate of shear, η_{∞} is the limiting viscosity at infinite rate of shear, and α and β are constants.

$$\begin{matrix}η = {η}_{∞} + \frac{{η}_{0} - {η}_{∞}}{1 + {αγ}^{2 / 3}} & . Equation 6 ) \\ σ = {η}_{∞} γ + \frac{{η}_{0} - {η}_{∞}}{β} σ ι v {η}^{- 1} ( βγ ) & ( Equation 7 )\end{matrix}$$

Specific mathematical models have also been developed for the time-dependent thixotropic fluids. As previously mentioned, thixotropic foods will experience a viscosity decrease over time when maintained under a steady shear rate. These various models integrate structural breakdown parameters which quantify the loss of viscosity. The coefficient of thixotropic breakdown with time (B) was measured at constant shear rate (Equation 8). They also provided a coefficient of thixotropy due to increase of shear rate (M) which indicates the loss in shear stress per unit increase in shear rate (Equation 9).

$$\begin{matrix}B = \frac{{η}_{1} - {η}_{2}}{ln ( {t}_{2} - {t}_{1} )} & ( Equation 8 ) \\ M = \frac{{η}_{1} - {η}_{2}}{ln ( {N}_{2} / {N}_{1} )} & ( Equation 9 )\end{matrix}$$

where η₁ and η₂ are viscosities measured after time 1 and time 2 and viscosities evaluated at angular speeds N₂ and N₁, for equations 8 and 9 respectively.

A kinetic rheological model can be used to characterize the thixotropic behavior of mayonnaise. Based on the Herschel-Bulkley model, this model also considered a decay structural parameter (λ) which ranged between 1 for zero shear time to equilibrium value (less than 1; Equations 10 and 11).

$$\begin{matrix}σ = λ ( {σ}_{0} + μ {γ}^{v} ) & ( Equation 10 ) \\ \frac{δ λ}{dt} = - {{K}_{1} ( λ - {λ}_{ɛ} )}^{2} φ o ρ λ > {λ}_{ɛ} & ( Equation 11 )\end{matrix}$$

where σₒ, M, N, K and λₑ are determined by experimental evaluations. Following the obtention of these data, the thixotropic behavior of a food product could be completely expressed.

Two more mathematical models were developed to describe the flow behavior of thixotropic fluids: the Weltman's model and the Hahn model (Equations 12 and 13, respectively).

σ=A₁−B₁ log t (Equation 12)

log(σ−σ_{ε})=A₂−B₂t (Equation 13)

where σ_{E} is the equilibrium shear stress, t is the time in seconds, and A₁ and A₂ are constants that indicate the initial shear stresses and B₁ and B₂ are constants indicating the rates of structural breakdown.

Temperature is another factor that also affects the viscosity of fluids. Generally, the effect of temperature on viscosity could be expressed by the Arrhenius relationship (Equation 14). values of activation energy were collected for a certain number of foods such as diluted fruit juices, egg products, concentrated fruit juices and pureed fruits.

η_{α}=η_{∞}^{Ea/RT} (Equation 14)

where Ea is the activation energy in kcal/(g·mol), R is the gas constant and T is the temperature in Kelvin.

It is also recognized that the concentration of a product influenced the viscosity. It was observed that an increase in concentration will induce an increase in viscosity. Concentration could convey an exponential relationship or a power type relationship on apparent viscosity. In the latter, the effect of temperature and concentration on viscosity can be combined into one equation (Equation 15):

$${η}_{α} = α ɛ ξ π \frac{( {E}_{α} )}{RT} {χ}^{β} \qquad ( Equation 15 )$$

### Instrumental Evaluation

Several fundamental and empirical methods have been developed over the years to permit the quantification of viscosity of fluids.

Mostly used for Newtonian liquids, the capillary flow method uses a viscometer usually made of glass which requires gravity or pressure force (piston) to allow standard quantity of liquid to flow through a capillary section. Two points are identified on the capillary and the pressure drop between them is calculated. Certain considerations have to be controlled for: a) the product must run with a steady flow, b) no end effect must be present and c) velocity must only be a function of axial distance. Several designs of capillary viscometers exist.

Concentric cylinders are also used to determine viscosity. Two types of viscometers are available: Couette or Searle type. The former presents a stable inner cylinder placed within a rotating outer cylinder. The outer cylinder is stable in the latter. The gap between both cylinders is very narrow which permits one to consider that the liquid is moving according to a steady and laminar flow (streamline flow). The force with which the liquid travels within the gap is recorded by a torque sensor. This type of equipment allows for continuous measurements at varying shear rates. A well known instrument of this type is the Haake Rotovisco viscometer.

The Cone and Plate viscometer is an instrument on which the sample is placed between a plate and a cone of small angle. Again, the torque created by the fluid as it turns is recorded. This system is particular for its stable shear rate at any point in the fluid. This is interesting when testing non-Newtonian liquids. Certain advantages of this instrument are quite interesting: 1) it provides no end-effect (no distortion due to rims or geometry), 2) a very small quantity of liquid is required (2 mL) and 3) it is quite easy to maintain the desired testing temperature due to the thin surface of contact.

Quantification of the consistency of thickened liquids and modified texture foods could be obtained using different apparatus. In 1996, Mann and Wong (J. Am. Dietetic Assoc. 96:585-588) presented an objective and simple method to assess consistency of thickened liquids and pureed foods offered to the dysphagic population. The line spread test measures the flow of 50 ml of a given product when placed on a flat surface. The product is placed in a hollow cylinder of 3.5 cm high and 5 cm of internal diameter. This cylinder is placed at the center of a Plexiglass™ sheet. The latter is positioned on a chart presenting concentric rings drawn every 5 cm. The tube is lifted and the product is allowed to flow for 1 minute. The distance traveled by the product is measured at each 90° angle and the measured results are averaged to give the line spread reading. The line spread test was strongly correlated (R=0.90 to 0.96) with the sensory panel evaluation of the scaling of various products. The authors concluded that the line spread test was reliable, valid, objective and an inexpensive tool to assess consistency. Other methods such as the BOSTWICK™ consistometer are available to evaluate flowability of semi-solid products and is currently used as a quality control tool in Step-Anne Hospital. Ranges of clinically efficient consistencies have not been published and each hospital or medical center is bound to standardize internally to insure quality control.

Several studies report the viscosity of fluids or semi-solid foods such as regular juices, juice concentrates, stirred yogurts or pureed fruits (Rha et al., Food Technol (1978) 32:77-82; Saravacos, (1970) J. Food Sci. 35:122-125) However, the analysis of the viscosity of thickened liquids used in the clinical treatment of dysphagia is rarely reported in the literature. It was suggested that ‘wide range upper and lower viscosity’ boundaries to quantify and standardize the thickened liquids used in the treatment of dysphagia. The viscosity ranges were expressed in centipoises (cP) and stated for a shear rate of 50 s⁻¹: 1 to 50 cP for the thin liquids, 51 to 350 cP range for the Nectar-like liquids, 351 to 1750 cP for the Honey-like liquids and not less than 1751 cP for the spoon-thick liquids. A wide range system of viscosity for thickened liquids would provide standards to which the industry will have to comply and would provide thickened liquids that correspond to a wide range of patients' needs.

### Rheology of Solids

Solids are usually described by their textural characteristics. Texture is defined by the Collins English dictionary as ‘the surface of a material especially as perceived by the sense of touch’ and as ‘the general structure and disposition of the constituent parts of something’. Food texture is generally characterized as the way in which the structural components of a food are arranged in a micro- and macro-structure and the exterior manifestations of this structure. The International Organization for Standardization (Standard 5492/3, 1979) has also defined texture as all the rheological and structural parameters of foods perceived by the mechanical, tactile and when possible, visual and audiologic receptors. Texture is a complex and multi-factorial food characteristic and should be considered for its overall attributes and not as an independent element.

### Instrumental Evaluation

Over time, several imitative tools were created to relate the sensory evaluation of the texture of foods and a more mechanical and objective measure. The existence of many instruments such as the shear-press, gelometers, viscometers, penetrometers, compressimeters, consistometers and tenderometers was reported. They stated that these instruments were of interest but could only derive the values of a limited number of textural characteristics and did not integrate the totality of the textural profile of the evaluated foods. These limitations were taken in consideration when Friedman and colleagues (Shepherd, (1972) 3:171-174) developed the texturometer, an instrument based on the MIT denture tenderometer. The tenderometer was an instrument imitating the masticatory action of the human mouth. The chewing action and penetration force were monitored and recorded. Other structures such as cheeks and gums were also simulated on this instrument. The tenderometer was the prototype used to develop the texturometer.

The texturometer was elaborated by replacing the dentures by a plunger and plate unit, providing several chewing speeds and adding a viscosity measurement unit. Other mechanical modifications such as the strain-gauge displacement and the adding of the strip-chart recorder were done. This instrument would provide profiles based on a force-distance relationship of food products correlated to definitions of mechanical texture characteristics elaborated by Scezniak (J. Food Sci. (1963) 385-389; J. Food Sci. (1963) 28:410-420; Scezniak et al., J. Food Sci. (1963) 397-403).

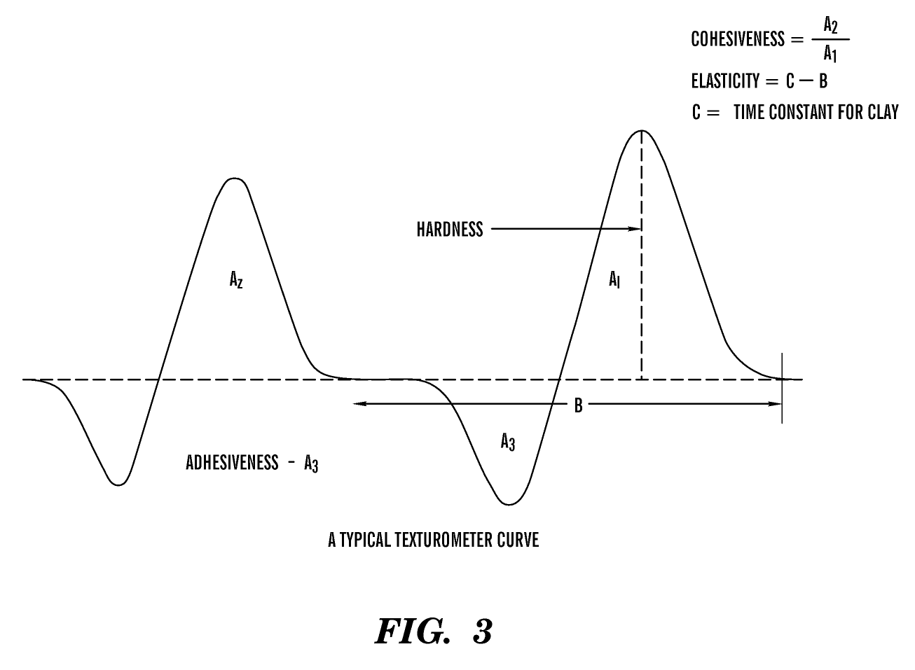

This new instrument was now able to evaluate certain physical characteristics of foods and generate a texture profile analysis (TPA) (FIG. 3). The TPA would provide information on several textural parameters such as firmness, adhesiveness, cohesiveness, springiness, gumminess and chewiness of the product. This instrumental evaluation of foods by the TPA can be correlated to a sensory evaluation. TPA is dependent upon: 1) primary and secondary mechanical characteristics of food, 2) geometrical characteristics including the composition of food particles and 3) food composition. The definitions of the primary textural characteristics (firmness, cohesiveness, adhesiveness and springiness) are as defined above.

The secondary mechanical characteristics are as follows:

Gumminess is defined as the energy required to disintegrate a semi-solid food product to a state ready for swallowing. It is related to the primary parameters of firmness and cohesiveness (F.C). It is expressed in Newton.

Chewiness is defined as the energy required to masticate a solid food product to a state ready for swallowing. It is related to the primary parameters of firmness, cohesiveness and springiness (F.C.S). It is expressed in Newton.

### Correlation Rheology/Clinical Efficacy

Historically, the main reasons for desiring a correlation between sensory evaluation and instrumental readings are: 1) the need for quality control; 2) the desire to predict consumer response; 3) the desire to understand what is being perceived in sensory texture assessment and 4) the need to develop improved/optimized instrumental test methods to ultimately construct the texture testing instrument that will duplicate the sensory evaluation. All these reasons remain fundamental when dysphagia treatment is considered. Knowing that the complex sensory system present in a healthy mouth is altered by neurological and/or muscular impairments renders the correlation of the sensory evaluation and the instrumental evaluations even more difficult but nonetheless essential in the treatment of dysphagia.

Three ranges of viscosities using the Brookfield DV-1 rotary viscometer to describe liquids as well as solids are now known. The ranges are 250 to 800 cP for thickened liquids, 800 to 2000 cP for thin purees such as cream soups with pureed vegetables and over 2000 cP for thick purees such as meats, casseroles and puddings in order to correlate the clinical investigation to the dietary prescription. No clinical trial has been associated with these ranges; therefore, the clinical efficacy of this approach remains to be demonstrated.

No study has been published relating the TPA or any other textural evaluation to the modified texture food items required in the dysphagia diet. Rheology offers a standardized terminology that is generally used in the food industry to establish standard recipes and to assess quality control and could benefit the dysphagia diet interpretation. The modified texture foods would also benefit a quantification of the food texture parameters. A better understanding of the textural characteristics of the foods, a better control of the rheological parameters and an association with clinical impairments in dysphagia patients would allow a standardization and better application of the prescribed diet.

### Dysphagia Diet

Specialized modified texture foods were developed to provide nutritious foods, adequate hydration and quality of life to those patients presenting dysphagia. The thickened liquids are prepared in 3 consistencies named Nectar, Honey and Pudding. The solid foods are modified to ground or pureed texture and reshaped, using molds, into their normal counterpart shapes. The meats are offered in ground or pureed textures whereas the fruits, vegetables and cakes are offered in pureed texture only.

Clinically, the foods are used mainly in 3 diets to provide safe-to-swallow nutritious meals to dysphagic individuals. Each of these diets requires individualization to consider personal taste and physical capacity. The three diets could be defined as:

Minced diet: this diet offers meats and combined dishes of minced texture. Also, soft dishes such as omelets, pasta dishes and shepherd's pie could be offered. Vegetables are usually of regular texture and well cooked. Desserts are tender but certain particles could be present such as fruit morsels or tapioca pearls. This diet will help with a dentition problem or will allow to reduce fatigue during a meal. At SAH, the minced diet will offer reshaped minced meats with sauce of nectar consistency, soft regular vegetables and tender desserts.

Minced-Pureed diet: As its name stipulates, this diet will offer minced meat and soft combined dishes but the vegetable will also have a pureed texture. Desserts have to be tender and present no particles. Again, this diet will reduce fatigue induced by mastication. The texture will help with the formation of a cohesive bolus. At SAH, the Minced-Pureed diet will offer reshaped minced meats with sauce of nectar consistency, reshaped pureed vegetables and reshaped pureed desserts without any particle such as milk puddings and applesauce.

Pureed diet: the pureed diet will have meats, combined dishes, vegetables and desserts of pureed texture. This type of feeding will help in the formation of a cohesive bolus and will reduce the energy required to eat and swallow. The pureed diet also reduces the mouth residues that could end up in the sulci, valleculea and the pyriform sinus. This diet will permit reshaped pureed meats with nectar consistency sauces, reshaped pureed vegetables, reshaped pureed desserts or desserts that are soft and without any distinct particles.

### Thickened Liquids

Although certain commercial thickened liquids are available, the production of thickened liquids is usually assumed by the health center where patients reside for cost and quality control reasons. Therefore, the methods of production and the resulting products will not only vary among hospitals, but also among therapists and from batch to batch as it was well pointed out by Glassburn and Deem. To limit this variability, SAH opted for a single production center where all the liquids were to be prepared and controlled for consistency reliability.

Introduced in 1991 at SAH, the thickened liquids were developed to allow individuals with oro-pharyngeal dysphagia to maintain a healthy level of hydration. This condition affects approximately 10% of SAH's clientele. The thickened liquids are made from any regular liquid, cold or hot, and thickened with a commercial thickener such as modified pre-gelatinized starch or a combination of different thickeners. The selection of thickened liquids comprises cranberry, apple, orange and prune juices, milk, milkshakes along with banana, chocolate, vanilla and strawberry supplements.

Originally, the thickened liquids were developed with the Dietary Department and Occupational Therapy department of SAH. Both departments had to evaluate the proper consistency required to adequately hydrate patients presenting several possible oro-pharyngeal dysfunctions.

The thickened liquids were developed in 3 consistencies named Nectar, Honey and Pudding to respond to various clinical needs. The Nectar consistency represented liquids with a certain body but still able to flow or be sipped from the cup. It is thicker than a regular fruit nectar and usually used to diminish the risk of premature leakage of the liquid in the pharynx or seepage from the mouth. The Honey consistency is thicker than the Nectar consistency and could be visualized as liquid honey at room temperature (23° C.). It will flow but at a slower pace than the Nectar liquid. This liquid is easier to hold on the tongue and allows more control during the oral phase of the swallow. The Pudding consistency is the thickest. It was formulated to look like a milk-based pudding dessert. It keeps its shape and requires a spoon to be eaten. It is usually offered to individuals who cannot hold a thin liquid on the tongue to propel it into the pharynx safely or to individuals with a slow swallowing reflex.

These particular consistency ranges were standardized using the BOSTWICK™ consistometer (CSC Scientific Company, Co, Fairfax, Va., 22031). This stainless steal instrument presents 2 cavities. A reservoir portion is separated by a guillotine gate from a longer portion. The longer cavity is graduated in half-centimeter sections which begin at the gate. The thickened liquids were first thickened by the clinicians according to what they believed was the proper consistency and than measured via the consistometer. The measures were made after the instrument was leveled and 90 ml of thickened liquid, at 8° C., was placed in the reservoir. The gate was lifted and the distance traveled by the thickened liquid was noted after 30 seconds.

To insure standardization of the final products, the ingredients are verified, weighed and identified at the Ingredients and Standardization Center of SAH's kitchen. The ingredients are given to a cook of the Specialized Food Production Center. Most of the thickened liquids are produced in bulk in a vertical cutter (Stephan, UM 44A). Quantity of lesser volumes are produced with a Braun™ hand mixer. The liquids are refrigerated in a walk-in refrigerator for 18 to 24 hours at 4° C. This waiting period allows for complete hydration of the thickeners and permits quality control and modification of inadequate batches. The thickened liquids are portioned in 125 ml cups using an automatic rotary filler (Vitality Rotary System RS3, Lykes Pasco, Fla., US). A plastic lid is put on and each cup is identified according to the type and consistency of the product.

Several of the thickened liquids are produced using a pre-gelatinized modified starch at different concentration levels according to the initial product and the consistency desired. To increase efficiency in the production of these products and to reduce repetition, a certain number of smaller batches' volumes were augmented and standardized to support freezing. To obtain a freeze-thaw stable thickened product, other thickening agents were introduced in the formulation. The production method remains the same but the products are sent to a walk-in freezer (−8° C.) until further use. Formulations are constantly re-evaluated to maintain the consistency within SAH's standard ranges and to compensate for the lack of control of the original liquid being thickened.

### Reshaped Modified Texture Foods

In 1995, SAH's dietary team decided to evaluate the foods most frequently offered to its dysphagic population: the foods of the minced and pureed diets. The traditional preparation methods included cooking the food, mincing or pureeing it and serving it with a ladle as several bowls in the plate. To increase nutrient density and to add to the appearance, the meats, vegetables and fruits were molded back into shape. Cakes were also pureed and reshaped to provide a better selection of foods available to the dysphagic population and increase their quality of life. This approach was believed to stimulate appetite, increase recognition of the food and offer a meal that was interesting to eat or to feed to someone else.

Therefore, these foods were developed within the Dietary Department with the help of the food production team, the clinical dietitians and dysphagic clients. Qualitative descriptions of what was needed as texture profiles for various population presenting various clinical profiles were established and the reshaped foods' recipes were formulated according to these 2 general statements: 1) the pureed foods had to be tender, cohesive without any grains or lumps and moist without letting water or fluids trickle out (syneresis) and 2) the minced foods had to be cohesive and offer a ground texture that would be felt on the tongue. Several formulations were developed and the foods were standardized using highly descriptive and qualitative descriptors. Still today, the developing team functions with the qualitative organoleptic evaluations to elaborate new foods but feels the need for a more uniform vocabulary and descriptions that could be quantified.

To insure a good control of the final products, all the ingredients entering a reshaped food recipe are verified, weighed and identified at the Ingredients and Standardization Center of SAH's kitchen. The ingredients are given to a cook of the Specialized Food Production Center to be prepared. The reshaped foods are can be separated in two main groups: 1) recipes requiring cooking period and 2) recipes made from cold products. The recipes requiring cooking are prepared as a regular recipe in a steam-jacketed pot. All the initial ingredients are in ground form or a finer texture. Cooking time will vary according to the recipes' needs. The mixture will be transferred into a vertical cutter (Stephan, UM44A) and processed until a pureed consistency is reached. For the meat recipes, part of the cooked mixture is not be pureed and will be portioned directly into the molds, sealed and quick frozen (−20° C.). This provides the ground reshaped meats. The ingredients for the recipes requiring no heating (fruits, Chef's salad and cakes) are blended directly in the vertical cutter (Stephan, UM44A) and processed until the pureed consistency is obtained. The mixture is placed into molds, sealed, quick-frozen (−20° C.) and stored.

The present invention will be more readily understood by referring to the following examples which are given to illustrate the invention rather than to limit its scope.

### Example 1

### Rheological Evaluation Modified Texture Products

### Introduction

In this section, the rheological parameters of some modified texture foods offered as SAH's dysphagia diet were evaluated. The apparent viscosity, the consistency coefficient, the flow behavior index and the yield stress of most thickened beverages were evaluated with a Searle type viscometer. Seven textural parameters of SAH's modified texture foods were evaluated to provide the first quantitative evaluation of thickened beverages and modified texture foods used in a clinical setting. For each sub-section, the results are presented followed by a discussion which highlights previous work published in the area of rheology and dysphagia. Conclusions are drawn and placed in the perspective of the clinical treatment of dysphagia.

### Thickened Beverages

To obtain a better understanding of the rheological variables affecting the viscosity and consistency of thickened beverages used in the clinical treatment of dysphagia, rheological analyses were performed on SAH's thickened beverages. This study of SAH cold thickened beverages had 2 main objectives:

a) Describe, measure and quantify objectively the cold, non-carbonated, thickened beverages used in the clinical treatment of dysphagia at SAH, and b) Evaluate possible correlation between the 3 consistency groups and rheological parameters such as apparent viscosity, consistency coefficient, flow behavior index and yield stress values

### Methods

SAH's thickened beverages were prepared according to their usual method and formulation (Tables 1a & 1b) and kept in a refrigerator for 24 hours at 6° C. They were evaluated for their viscosity with the Haake Rotovisco RV2 (Haake, Germany) coaxial cylinder sensor system. The Searle type viscometer was fitted with the M5 OSC measuring head and the MV1 rotor system (Ro=20.04 mm; h=60 mm) was placed within a cylindrical cup (Ri=21 mm). The temperature was maintained at 8° C. using a circulating waterbath (Haake, Fk-2 Model). This measuring head and rotor system were used because of the wide range of viscosity it could measure. The instrument was linked to a computer for control and constant data collection. The Rotovisco RV20 Software (Version 2.3.15, Haake, Germany, 1990) was used to determine the best mathematical model for the evaluation of these thickened beverages.

### Table 1

### Examples of Food Formulations

TABLE 1a
THICKENED APPLE JUICE (Nectar, Honey and Pudding consistencies)

| | | Nectar | Honey | Pudding | | |
|---|---|---|---|---|---|---|
| INGREDIENTS | | % | % | % | Equipment | METHOD |
| 1 | Apple juice, made from | 95.48 | 94.24 | 91.42 | Vertical cutter | 1. Mix. |
| | concentrate, pasteurized | | | | | |
| 2 | Corn starch, modified, pre- | 4.52 | 5.76 | 8.58 | | |
| | gelatinized | | | | | |

| | | | |
|---|---|---|---|
| Total | 100.00 | 100.00 | 100.00 |

TABLE 1b
THICKENED MILK (Honey consistency)

| | | Honey | | |
|---|---|---|---|---|
| INGREDIENTS | | % | Equipment | METHOD |
| 1 | Partially skimmed milk, 2% | 94.57 | Vertical cutter | 1. Mix. |
| 2 | Corn starch, modified, pre- | 5.43 | | |
| | gelatinized | | | |

| | |
|---|---|
| Total | 100.00 |

Three samples of each cold, non-carbonated, thickened beverage produced with the usual production method at SAH were evaluated. The consistency of the samples was monitored, at 8° C., using the BOSTWICK™ consistometer. The samples had to be within the acceptable HSA clinical range to be evaluated for viscosity. An up-cycle varying the shear rate from 0 s⁻¹ to 100 s⁻¹ in 5 minutes followed by a stable period of 5 minutes at 100 s⁻¹ shear rate and a down-cycle of 100 s⁻¹ to 0 s⁻¹ of 5 minutes were performed to give a complete description of the various beverages studied.

First, the flow curves—also known as rheograms—of the increasing shear rate cycle were plotted. For each product, a linear regression was performed in order to obtain the value of the yield stress. Secondly, the log transformed data of the value resulting from the subtraction of the yield stress from the shear stress and the log transformed data of the shear rate were then calculated and plotted. Thereafter, a second linear regression was performed to obtain the slope and the intercept values. The slope and the antilog value of the intercept correspond to the n-value and the m-value respectively. Lastly, the apparent viscosity (ηₐ) at a shear rate of 50 s⁻¹ was determined for each product tested according to the H.-Bulkley model.

### Statistical Method

Student unpaired t-tests were performed for each rheological parameter (m- and n-values, yield stress and apparent viscosity) to compare the 3 different consistency groups. The consistency groups were further divided into high-protein content items and juice items. Student unpaired t-tests were calculated to compare both sub-groups within each consistency level. Probability of p<0.05 was considered statistically significant. A linear regression analysis was done to evaluate the correlation between the apparent viscosity, consistency coefficient, flow behavior index as well as the yield stress values and the consistency levels.

### Results

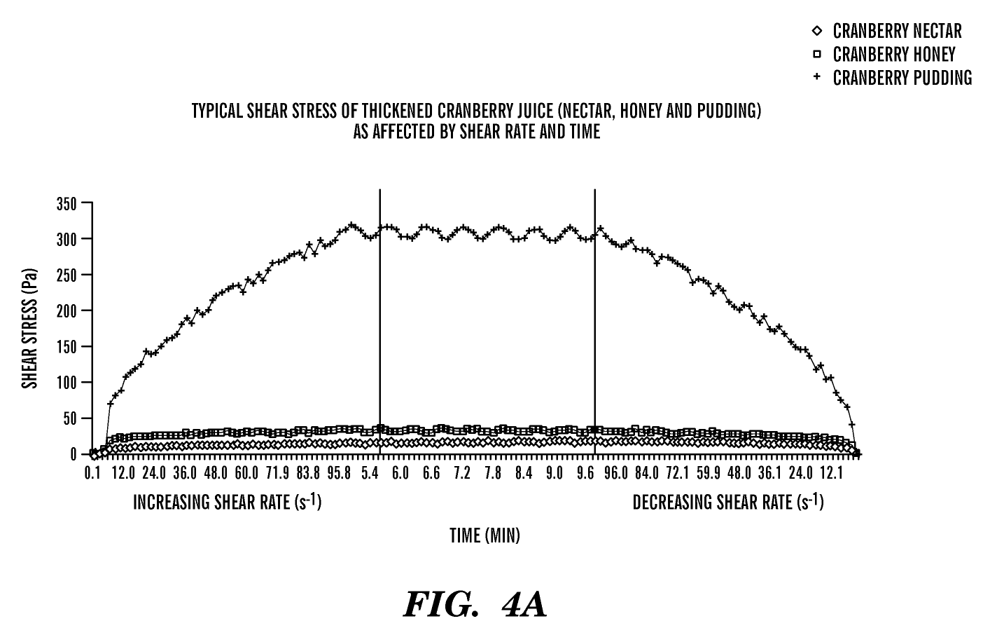

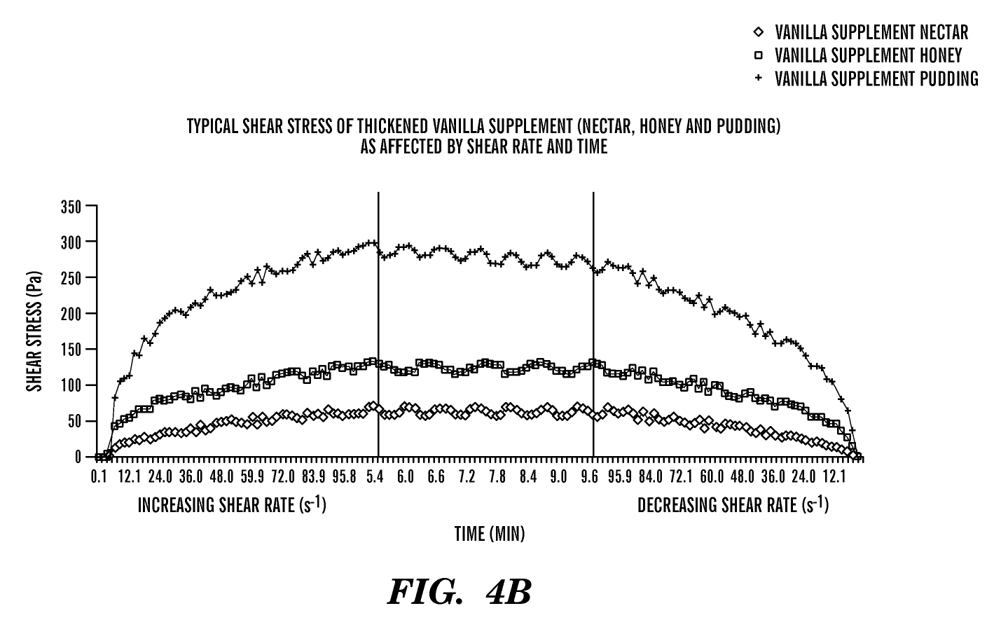

The BOSTWICK™ consistency of each sample evaluated respected the clinical standards developed at SAH. FIGS. 4a and 4b show typical rheograms of HSA thickened beverages. The first portion of the graphs (upward cycle) showed an increase in shear stress as shear rate in augmented whereas the down-cycle show a decrease in shear stress with reduced shear rate. The center portion demonstrated the time independence of the thickened products. Therefore, based on these rheograms, the products can be described as non-Newtonian and pseudoplastic with a yield stress. They demonstrated a shear-thinning behavior. The products best fitted the Herschel-Bulkley model.

Table 2 presents the average values of the consistency coefficient (m), flow behavior index (n), the yield stress (σₒ) and the values of the apparent viscosity (ηₐ) at 50 s⁻¹ of the upward portion of the curve for each product of each consistency group. The results of the upward and downward cycles were similar therefore, only the data of the first cycle are presented.

At each consistency level—Nectar, Honey and Pudding—the consistency coefficient, yield stress and viscosity values were found to be statistically different (p<0.05). The average values show high standard deviations demonstrating the wide range of physical composition of these products.

The consistency coefficient values of all test samples were greater than 1. They were statistically different for the 3 consistency levels (p<0.05). The Nectar products presented an average of 2.75±0.76 Pa·sⁿ (mean±SD) and ranged from 1.61 to 3.60 Pa·sⁿ. The Honey liquids presented an average m-value of 7.77±4.22 Pa·sⁿ with a range passing from 1.96 to 16.48 Pa·sⁿ. The Pudding beverages showed a 15.95±10.12 Pa·sⁿ consistency coefficient value that ranged from 5.07 to 36.24 Pa·sⁿ. The m-value increased almost 3-fold from the Nectar consistency to the Honey consistency whereas it doubled from the Honey consistency to the Pudding consistency.

All products demonstrated a yield stress. The yield stress values were of 3.44±2.92 Pa for the Nectar consistency, 13.48±9.83 Pa for the honey consistency and 44.06±26.92 Pa for the Pudding consistency. The yield stress augmented 4-fold from the Nectar consistency to the Honey consistency and more than 3-fold from the Honey consistency to the Pudding consistency.

The flow behavior index values of all test samples were below 1. They presented an average of 0.57±0.09 and ranged from 0.40 to 0.65 for the Nectar products. The Honey products presented an average n-value of 0.52±0.18 with a range going from 0.21 to 0.76. The Pudding beverages showed an average n-value of 0.54±0.11 which ranged from 0.35 to 0.68. The flow behavior index did not differ statistically from one consistency to the other (p>0.05).

TABLE 2
Consistency Index. Flow Behavior Index, Yield Stress and Apparent Viscosity of
Thickened Beverages, shear rate of 50 s−1 at 8° C.

| | | | | | | | | |
|---|---|---|---|---|---|---|---|---|
| m | | n | | | | | | |
| Index^{a} | SD | Index^{b} | SD | R² | YS^{c} | SD | Viscosity^{d} | SD |

Products of Nectar Consistency

| | | | | | | | | | |
|---|---|---|---|---|---|---|---|---|---|
| Vanilla | 2.93 | 0.50 | 0.65 | 0.03 | 0.96 | 7.67 | 0.50 | 904 | 36.25 |
| Supplement | | | | | | | | | |
| Strawberry | 3.58 | 0.66 | 0.64 | 0.04 | 0.95 | 7.69 | 1.55 | 1033 | 42.07 |
| Supplement | | | | | | | | | |
| Milkshake | 2.28 | 0.44 | 0.61 | 0.04 | 0.96 | 0.69 | 0.18 | 513 | 12.56 |
| Milk 2% | 3.34 | 0.52 | 0.57 | 0.03 | 0.95 | 1.82 | 1.67 | 654 | 19.35 |
| High Protein | 3.03 | | 0.62 | | 0.96 | 4.47 | | 776 | |
| Group Average | | | | | | | | | |
| High Protein | 0.56 | | 0.04 | | 0.00 | 3.74 | | 235 | |
| Group Std. Dev | | | | | | | | | |
| Prune Juice | 1.88 | 0.06 | 0.59 | 0.01 | 0.96 | 2.11 | 0.21 | 425 | 13.04 |
| Orange Juice | 3.60 | 0.22 | 0.47 | 0.01 | 0.97 | 0.28 | 0.24 | 463 | 9.55 |
| Apple Juice | 2.76 | 0.37 | 0.62 | 0.02 | 0.96 | 2.76 | 0.34 | 684 | 20.12 |
| Cranberry Juice | 1.61 | 0.39 | 0.40 | 0.03 | 0.92 | 4.52 | 0.14 | 239 | 17.32 |
| Juice Group | 2.46 [symbol] [symbol] | | 0.52 [symbol] [symbol] | | 0.95 | 2.42 [symbol] [symbol] | | 453 [symbol] [symbol] | |
| Average | | | | | | | | | |
| Juice Group Std | 0.90 | | 0.11 | | 0.02 | 1.75 | | 182 | |
| Dev. | | | | | | | | | |
| Group Average | 2.75 | | 0.57 | | 0.96 | 3.44 | | 615 | |
| Std. Dev. | 0.76 | | 0.09 | | 0.02 | 2.92 | | 261 | |

Products of Honey Consistency

| | | | | | | | | | |
|---|---|---|---|---|---|---|---|---|---|
| Banana | 1.96 | 0.73 | 0.66 | 0.07 | 0.94 | 15.32 | 2.26 | 807 | 9.20 |
| Supplement | | | | | | | | | |
| Vanilla | 9.16 | 1.95 | 0.53 | 0.04 | 0.94 | 29.56 | 4.38 | 2024 | 130.89 |
| Supplement | | | | | | | | | |
| Strawberry | 5.96 | 1.05 | 0.68 | 0.04 | 0.98 | 23.39 | 1.72 | 2129 | 54.23 |
| Supplement | | | | | | | | | |
| Chocolate | 9.20 | 0.29 | 0.60 | 0.00 | 0.97 | 23.26 | 1.30 | 2359 | 41.13 |
| Supplement | | | | | | | | | |
| Milkshake | 8.18 | 0.29 | 0.51 | 0.00 | 0.97 | 5.73 | 0.50 | 1307 | 17.70 |
| Milk 2% | 168.48 | 0.18 | 0.42 | 0.00 | 0.98 | 1.68 | 0.76 | 1749 | 53.29 |
| High Protein | 8.49 | | 0.57 | | 0.96 | 16.49 | | 1729 | |
| Group Average | | | | | | | | | |
| High Protein | 4.77 | | 0.10 | | 0.02 | 10.96 | | 578 | |
| Group Std. Dev | | | | | | | | | |
| Prune Juice | 7.28 | 0.70 | 0.71 | 0.02 | 0.98 | 18.42 | 0.75 | 2701 | 44.05 |
| Vegetable Juice | 2.97 | 0.68 | 0.44 | 0.06 | 0.94 | 4.88 | 1.28 | 427 | 17.45 |
| Orange Juice | 10.28 | 1.74 | 0.25 | 0.02 | 0.88 | 4.14 | 0.68 | 617 | 50.94 |
| Apple Juice | 3.14 | 0.22 | 0.76 | 0.02 | 0.97 | 18.46 | 0.53 | 1593 | 60.72 |
| Cranberry Juice | 10.90 | 0.80 | 0.21 | 0.01 | 0.88 | 3.40 | 0.95 | 560 | 8.02 |
| Juice Group | 6.91 | | 0.47 | | 0.93 | 9.86 | | 1180 | |
| Average | | | | | | | | | |
| Juice Group Std | 3.78 | | 0.26 | | 0.05 | 7.85 | | 969 | |
| Dev. | | | | | | | | | |
| Group Average | 7.77 [symbol] [symbol] | | 0.52 [symbol] [symbol] | | 0.95 | 13.48 [symbol] [symbol] | | 1479 [symbol] [symbol] | |
| Std. Dev. | 4.22 | | 0.18 | | 0.04 | 9.83 | | 790 | |

Products of Pudding Consistency

| | | | | | | | | | |
|---|---|---|---|---|---|---|---|---|---|
| Banana | 10.76 | 2.11 | 0.47 | 0.04 | 0.93 | 41.96 | 3.21 | 2184 | 46.83 |
| Supplement | | | | | | | | | |
| Strawberry | 20.27 | 3.33 | 0.47 | 0.06 | 0.92 | 113.75 | 1.29 | 4793 | 226.98 |
| Supplement | | | | | | | | | |
| Vanilla | 25.06 | 2.11 | 0.51 | 0.01 | 0.95 | 49.56 | 3.04 | 4693 | 194.55 |
| Supplement | | | | | | | | | |
| Chocolate | 9.34 | 1.84 | 0.64 | 0.05 | 0.98 | 51.79 | 3.67 | 3254 | 11.21 |
| Supplement | | | | | | | | | |
| Milkshake | 26.72 | 3.29 | 0.48 | 0.02 | 0.99 | 21.71 | 1.65 | 3896 | 188.62 |
| Milk 2% | 36.24 | 4.22 | 0.35 | 0.02 | 0.98 | 7.43 | 4.01 | 3015 | 58.48 |
| High Protein | 21.40† | | 0.49 | | 0.96 | 47.70 | | 3639 | |
| Group Average | | | | | | | | | |
| High Protein | 10.21 | | 0.09 | | 0.03 | 36.64 | | 1016 | |
| Group Std. Dev | | | | | | | | | |
| Vegetable Juice | 6.64 | 0.16 | 0.48 | 0.02 | 0.94 | 43.18 | 1.97 | 1748 | 42.21 |
| Prune Juice | 16.05 | 0.94 | 0.66 | 0.01 | 0.98 | 27.36 | 3.66 | 4880 | 404.17 |
| Orange Juice | 5.19 | 1.00 | 0.50 | 0.03 | 0.92 | 43.77 | 1.79 | 1602 | 50.63 |
| Apple Juice | 5.07 | 1.79 | 0.68 | 0.06 | 0.92 | 51.13 | 1.25 | 2397 | 197.77 |
| Cranberry Juice | 1.14 | 4.95 | 0.66 | 0.07 | 0.99 | 33.00 | 14.72 | 4272 | 47.73 |
| Juice Group | 9.42† | | 0.60 | | 0.95 | 39.69 | | 2980 | |
| Average | | | | | | | | | |
| Juice Group Std | 5.26 | | 0.10 | | 0.03 | 9.44 | | 1503 | |
| Dev. | | | | | | | | | |
| Group Average | 15.95 [symbol] [symbol] | | 0.54 [symbol] [symbol] | | 0.96 | 44.06 [symbol] [symbol] | | 3339 [symbol] [symbol] | |
| Std. Dev. | 10.12 | | 0.11 | | 0.03 | 26.92 | | 1240 | |

^{a}Consistency Index
^{b}Flow Behavior Index
^{c}Yield Stress
^{d}Viscosity calculated according to the Herschel Bulkley equation [symbol]
Products of Nectar Consistency versus Honey Consistency, p < 0.05 [symbol]
Products of Pudding Consistency versus Nectar Consistency, p < 0.05 [symbol]
Products of Honey Consistency versus Pudding Consistency, p < 0.05
†High Protein group versus Juice group, Pudding Consistency, p < 0.05

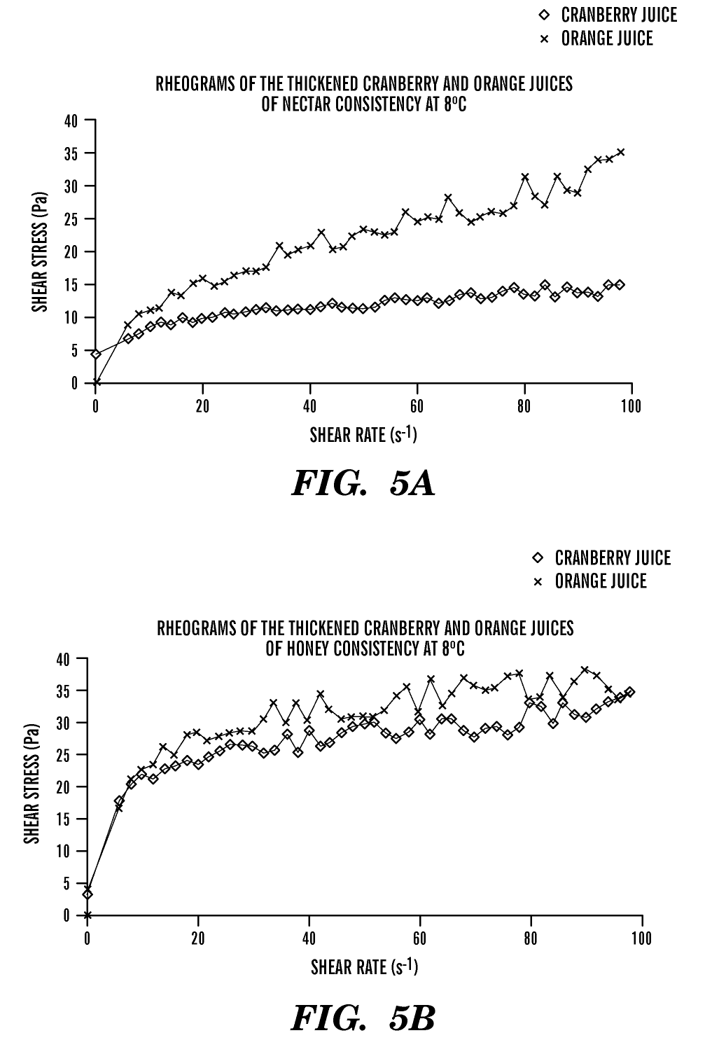

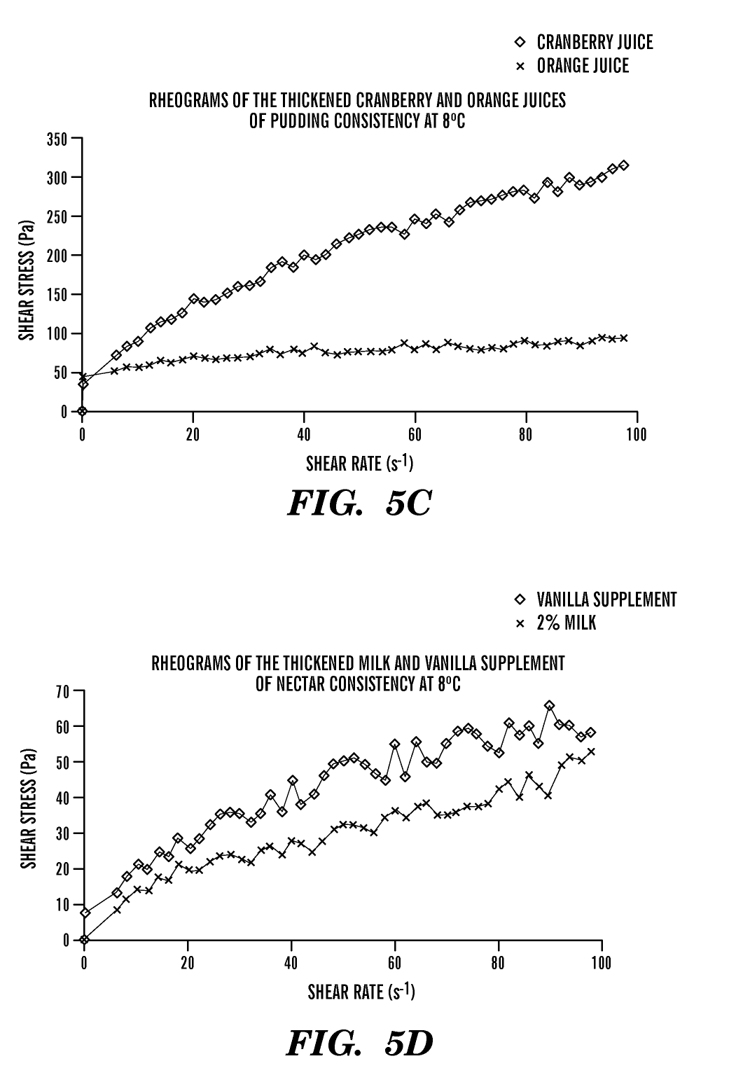

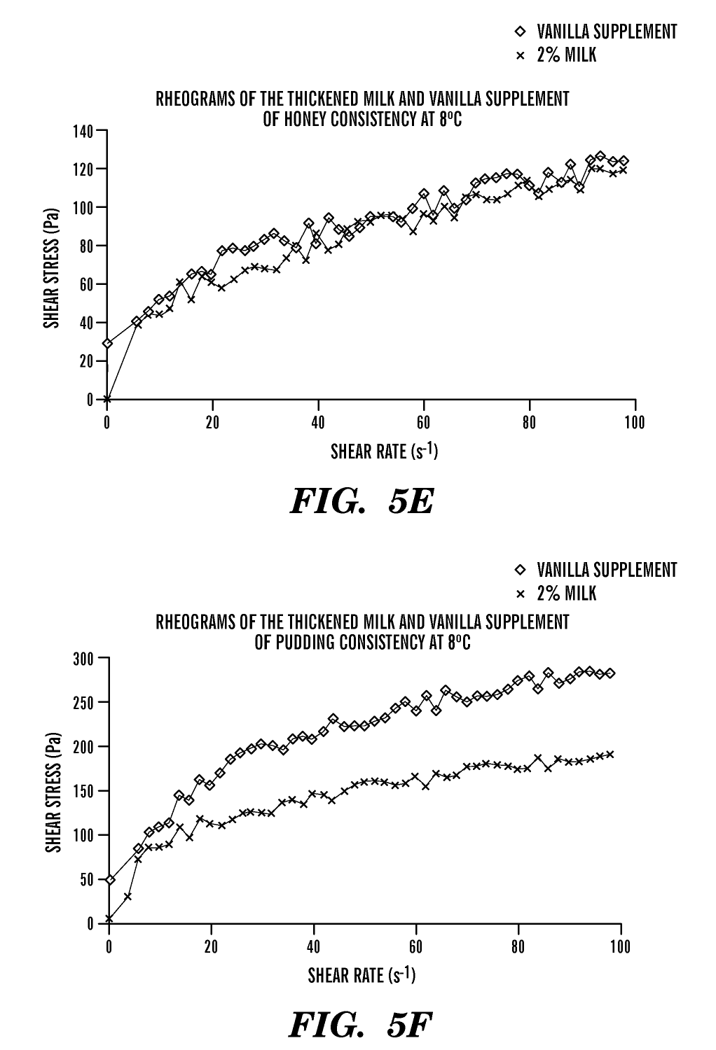

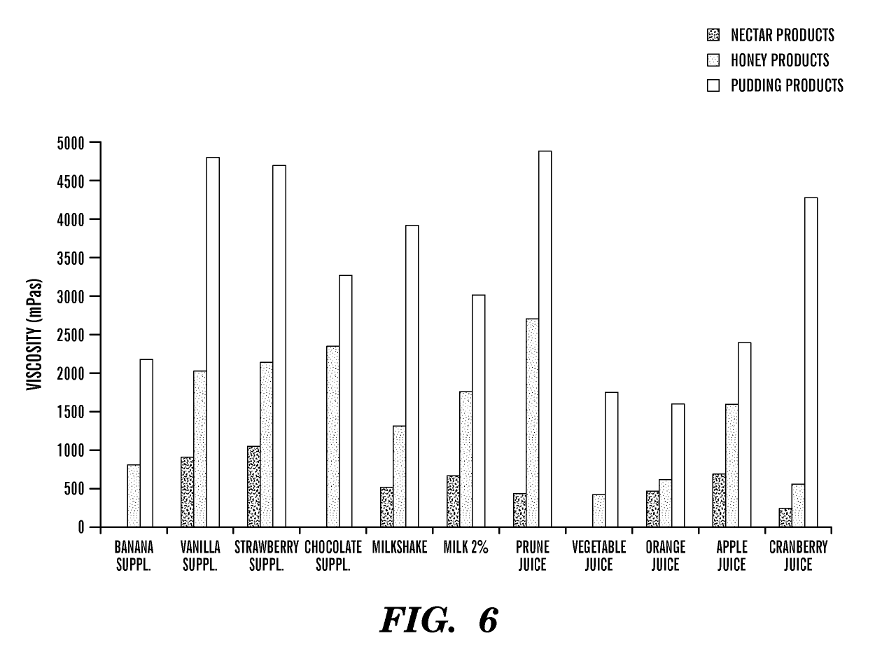

At a shear rate of 50 s⁻¹ and temperature of 8° C., the average viscosity value of the Nectar products was of 615±260 mPas, the Honey products had a viscosity of 1480±790 mPas and the Pudding products presented a 3340±1240 mPas viscosity. The viscosity values for the Nectar group ranged from 239±17 mPas for the cranberry juice to 1030±42 mPas for the strawberry supplement. Within the Honey consistency, the viscosity values ranged from 427±18 mPas for the vegetable juice to 2700±44 mPas for the prune juice. The Pudding consistency level displayed viscosity values of 1600±51 mPas for the orange juice up to 4880±400 mPas for the prune juice. FIGS. 5a to 5f describe typical flow curves of certain thickened products evaluated whereas FIG. 6 shows the high variability of the apparent viscosity ranges for different consistency products.

Since concentration and formulation are known to affect the apparent viscosity, each consistency group (Nectar, Honey and Pudding) was further divided into high-protein content products and juice products. It was found that only the consistency coefficient of the pudding consistency products displayed a statistically higher value for the high-protein product when compared to the juice products (p<0.04) but this could be due to the high standard deviations observed. Therefore, each consistency level was considered as 2 sub-groups: high-protein products and juices.

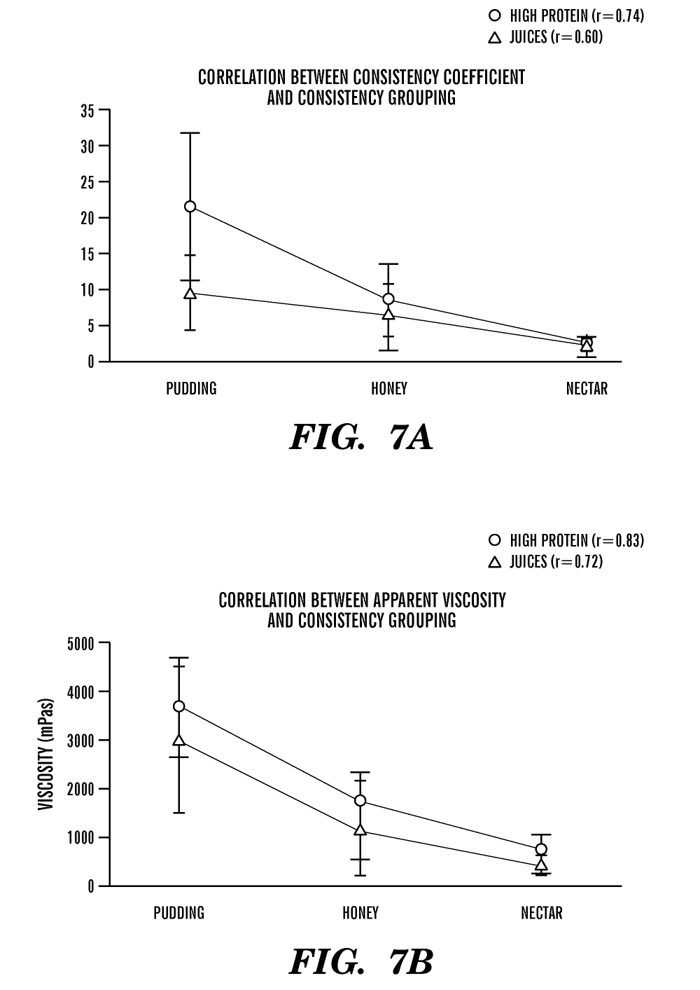

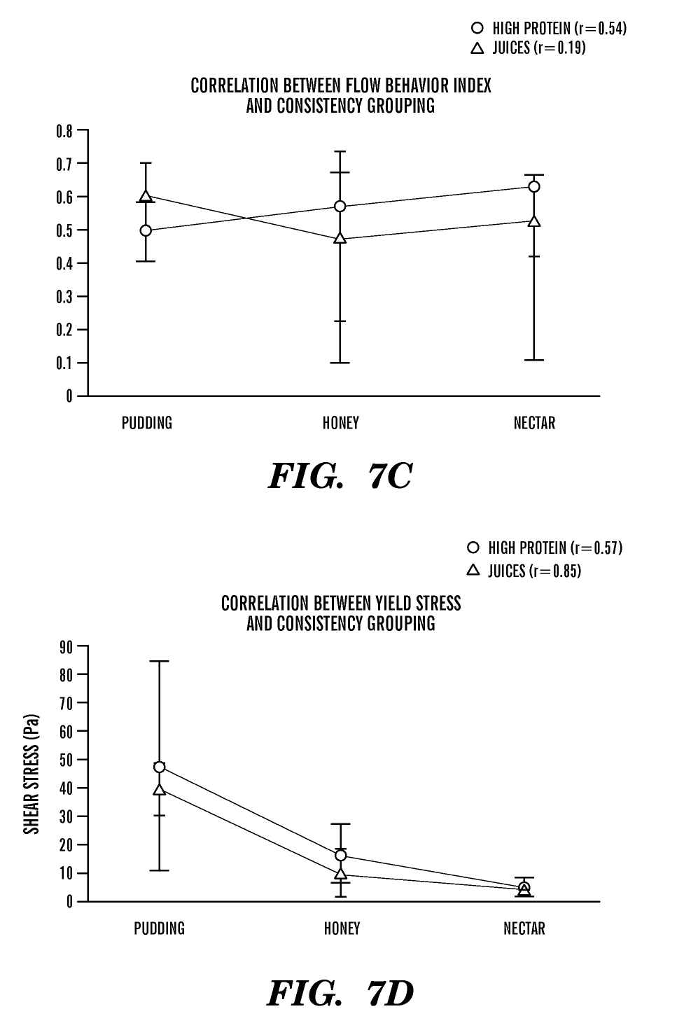

To verify the level of correlation between BOSTWICK™ consistency and apparent viscosity, we plotted the m-values, n-values, yield stress and apparent viscosity values as a function of the consistency levels (FIGS. 7a to 7d). Linear regressions were performed for each sub-group of products of Nectar, Honey and Pudding consistency.

The correlation coefficient between the consistency coefficient and the BOSTWICK™ consistency levels (Nectar, Honey and Pudding) was found to be R=0.74 and R=0.60 for the high-protein products and the juices, respectively. The apparent viscosity and the BOSTWICK™ consistency levels showed correlation coefficients of R=0.83 for the high-protein products and R=0.72 for the juices. The correlation coefficients were different for juice products with coefficients of R=0.85 than the high-protein products with R=0.57 when yield stress and the BOSTWICK™ consistency values are compared.

Thickened beverages have been used at SAH's since 1991 as a safe and positive method to maintain adequate hydration for dysphagic individuals while maintaining quality of life. This study was the first exhaustive evaluation of the rheological parameters of thickened beverages used in a clinical setting.

When analyzed for their rheological parameters, the SAH thickened beverages were found to be non-Newtonian, pseudoplastic, time-independent products. They all presented a yield stress and could be best described by the Herschel-Bulkley model.

Although various types of products composed each consistency group, no statistical difference was observed between the high-protein products and the juice products—except for the consistency coefficient in the Pudding group (p<0.05). The 3 consistency groups were statistically different for their consistency coefficient, yield stress and apparent viscosity (p<0.05) despite sometimes high standard deviation values.

When separated as high-protein and juice products, correlation between consistency coefficient, apparent viscosity, yield stress values and the BOSTWICK™ consistency could not be clearly established. The flow behavior index had no correlation with the consistency level.

Apparent viscosity could be an essential parameter when formulating new thickened beverages but no apparent viscosity ranges have yet been published demonstrating their clinical efficacy. Taking in consideration the positive health results observed at SAH with individuals receiving thickened beverages and the standardized approach used to produce the thickened beverages, we conclude that consistency is a critical and essential parameter to control in the treatment of dysphagia. The BOSTWICK™ method is relatively inexpensive, accessible to most and time efficient.

### Reshaped Foods

Using rheological instrumental methods, the first quantitative evaluation of reshaped minced and pureed foods was performed to provide a better understanding of their textural characteristics and eventually, help in the development of better tools for the treatment of dysphagia. This study has evaluated the texture profile analyses (TPA) of SAH modified texture reshaped foods with 2 main objectives:

1—Describe, measure and quantify objectively SAH's reshaped modified texture foods within the clinical food groups

2—Evaluate possible similarities of textural profiles of the solids within food groups

### Methods

SAH's reshaped foods were prepared according to their usual method and formulation (Tables 3a, 3b, 3c & 3d). They were tested using the Tensile Testing machine—texturometer (Lloyd Model LRX, Fareham, Hans UK) fitted with a 50N cell and a 50 mm diameter disk-shaped probe. All the samples (Width: 30 mm×Length: 30 mm×Height: 15 mm) were individually heated and tested at normal serving temperature (65° C.). Each sample of meat, taken from the center of a reshaped item, was heated to 65° C. using a microwave oven (Goldstar, LG Electronics Inc, Kyungsangnam-Do, Korea; 2450 mhz; 600 W) at an intensity of 60% for 60 seconds. Each vegetable sample was heated at 65° C. using the same microwave oven at an intensity of 40% for 40 seconds. The reshaped cakes were tested at 8° C.-12° C. A 2-cycle TPA compression test at a speed of 150 mm per minute was performed on 8 replicates of each reshaped food available. The data was gathered via the RCONTROL DATA ANALYSIS SOFTWARE™ (version 3.2, 1995).

### Table 3

### Reformed Food Formulations

TABLE 3a
PUREED BEEF FORMULATION

| INGREDIENTS | | % | Equipment | METHOD |
|---|---|---|---|---|
| 1 | Water | 13.21 | Steam cooker | 1. Mix and cook. |
| 2 | Minced beef, lean, raw | 77.08 | | |
| 3 | Beef stock | 0.99 | same | 2. Add to the meat and cook. |
| 4 | Onion powder | 0.22 | | |
| 5 | Garlic powder | 0.13 | | |
| 6 | Salt | 0.32 | | |
| 7 | Pepper | 0.10 | | |
| 8 | Soy protein concentrate | 0.67 | same | 3. Add to the seasoned meat and cook. |
| 9 | Carrageenan | 0.67 | | |
| 10 | Water for puree | 6.61 | Vertical cutter | 4. Transfer the meat, add water and |
| | | | | puree. |
| | Total: | 100.00 | | 5. Place mixture into molds and seal. |
| | | | | 6. Freeze. |
| | | | | 7. Keep stored in freezer. |
| | | | | 8. Remove from molds while frozen. |
| | | | | Place in a dish. |
| | | | | 9. Cover with aluminium foil. Heat. |

TABLE 3b
MINCED BEEF FORMULATION

| INGREDIENTS | | % | Equipment | METHOD |
|---|---|---|---|---|
| 1 | Water | 14.15 | Steam cooker | 1. Mix and cook. |
| 2 | Minced beef, lean, raw | 82.53 | | |
| 3 | Beef stock | 1.06 | same | 2. Add to the meat and cook. |
| 4 | Onion powder | 0.24 | | |
| 5 | Garlic powder | 0.14 | | |
| 6 | Salt | 0.34 | | |
| 7 | Pepper | 0.11 | | |
| 8 | Soy protein concentrate | 0.72 | same | 3. Add to the seasoned meat and cook. |
| 9 | Carrageenan | 0.72 | | |
| | Total: | 100.00 | | 5. Place mixture into molds and seal. |
| | | | | 6. Freeze. |
| | | | | 7. Keep stored in freezer. |
| | | | | 8. Remove from molds while frozen. |
| | | | | Place in a dish. |
| | | | | 9. Cover with aluminium foil. Heat. |

TABLE 3c
PUREED YELLOW BEANS FORMULATION

| INGREDIENTS | | % | Equipment | METHOD |
|---|---|---|---|---|
| 1 | Water | 45.81 | Steam cooker | 1. Cook and strain. |
| 2 | Yellow beans, frozen | 45.81 | | |
| 3 | Chicken stock | 0.34 | Vertical cooker | 2. Transfer, add to yellow beans and |
| 4 | Soy protein concentrate | 0.46 | | puree. |
| 5 | Carrageenan | 0.25 | | |
| 6 | Water for puree | 7.33 | | |
| | Total: | 100.00 | Steam cooker | 3. Transfer and cook. |
| | | | | 4. Place mixture into molds and seal. |
| | | | | 5. Freeze. |
| | | | | 6. Keep stored in freezer. |
| | | | | 7. Remove from molds while frozen. |
| | | | | Place in a dish. |
| | | | | 8. Cover with aluminium foil. Heat. |

TABLE 3d
PUREED CARROT CAKE FORMULATION

| INGREDIENTS | | % | Equipment | METHOD |
|---|---|---|---|---|
| 1 | Granulated white sugar | 10.49 | Oven | 1. Prepare the cake dough and cook. |
| 2 | Canola oil | 6.99 | | |
| 3 | Eggs, fresh, medium size | 3.76 | | |
| 4 | Fresh carrots, grated | 6.40 | | |
| 5 | Canned pineapple, | 7.27 | | |
| | pieces, in juice, sol + liq | | | |
| 6 | White flour, all-purpose | 3.75 | | |
| 7 | Whole wheat flour | 3.37 | | |
| 8 | Cinnamon, ground | 0.02 | | |
| 9 | Baking soda | 0.22 | | |
| 10 | Salt | 0.17 | | |
| 11 | Coconut, sweet, grated | 2.55 | | |
| 12 | Walnuts, dried, chopped | 2.70 | | |
| 13 | Pineapple juice, from | 39.89 | Vertical cutter | 2. Transfer the cake, add remaining |
| | concentrate | | | ingredients then puree. |
| 14 | Gelatin, neutral | 1.12 | | |
| 15 | Water | 11.29 | | |
| | Total: | 100.00 | | 3. Place mixture into molds and seal. |
| | | | | 4. Freeze. |
| | | | | 5. Keep stored in freezer. |
| | | | | 6. Remove from molds while frozen. |
| | | | | Place in a dish. |

### Statistical Methods

Reshaped foods were classified by family of products. Minimum and maximum values were calculated for all rheological parameters resulting from the TPA for each family of reshaped foods tested. Ranges were established for each (Tables 4 and 5).

TABLE 4
Pureed Foods Textural Profile Analysis Minimum and Maximum Values

| | Firmness 1 | | | | Springiness | | Adhesiveness | | Gumminess | | Chewiness | |
|---|---|---|---|---|---|---|---|---|---|---|---|---|
| | (N) | | Cohesiveness | | (%) | | (mm) | | (N) | | (N) | |
| Type | Min. | Max. | Min. | Max. | Min. | Max. | Min. | Max. | Min. | Max. | Min. | Max. |
| Meat | 0.714 | 4.58 | 0.163 | 0.407 | 1.28 | 12.481 | −0.414 | −1.326 | 0.136 | 1.567 | 0.522 | 14.381 |
| Vegetable/Fruit | 0.428 | 1.914 | 0.162 | 0.374 | 1.089 | 7.438 | −0.229 | −0.710 | 0.095 | 0.716 | 0.105 | 5.374 |
| Cakes (23° C.) | 1.057 | 2.577 | 0.224 | 0.454 | 4.774 | 35.985 | −0.164 | −1.380 | 0.356 | 1.177 | 1.915 | 24.139 |
| Cakes (8-12° C.) | 0.556 | 6.547 | 0.105 | 0.536 | 3.700 | 56.823 | −0.426 | −1.455 | 0.071 | 3.390 | 0.469 | 179.557 |

TABLE 5
Minced Foods Textural Profile Analysis Minimum and Maximum Values

| | Firmness 1 | | | | Springiness | | Adhesiveness | | Gumminess | | Chewiness | |
|---|---|---|---|---|---|---|---|---|---|---|---|---|
| | (N) | | Cohesiveness | | (%) | | (mm) | | (N) | | (N) | |
| Type | Min. | Max. | Min. | Max. | Min. | Max. | Min. | Max. | Min. | Max. | Min. | Max. |
| Meat | 1.119 | 10.078 | 0.117 | 0.353 | 1.471 | 22.196 | −0.221 | −1.102 | 0.228 | 3.433 | 0.456 | 26.006 |

### Results

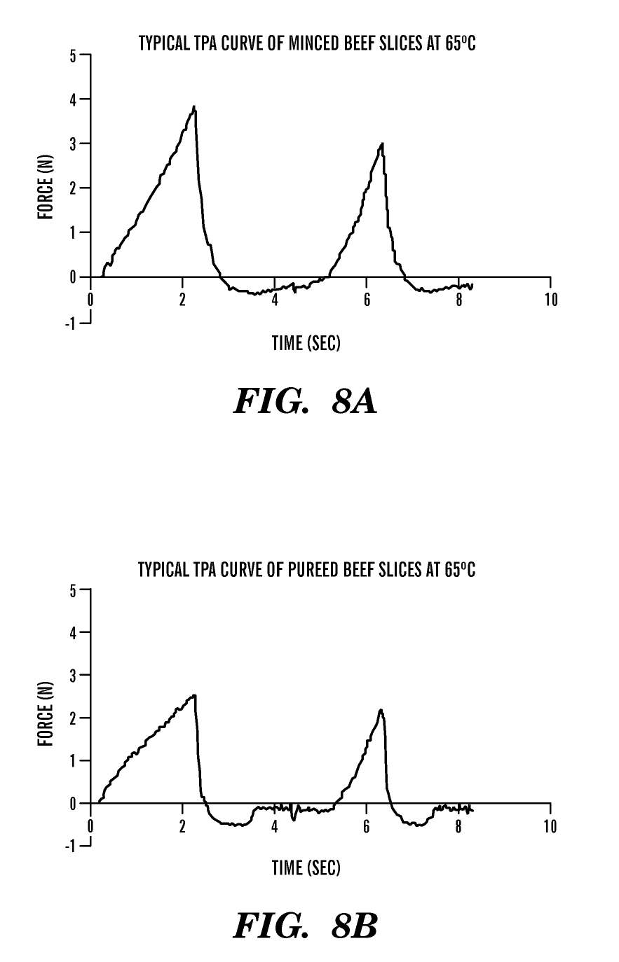

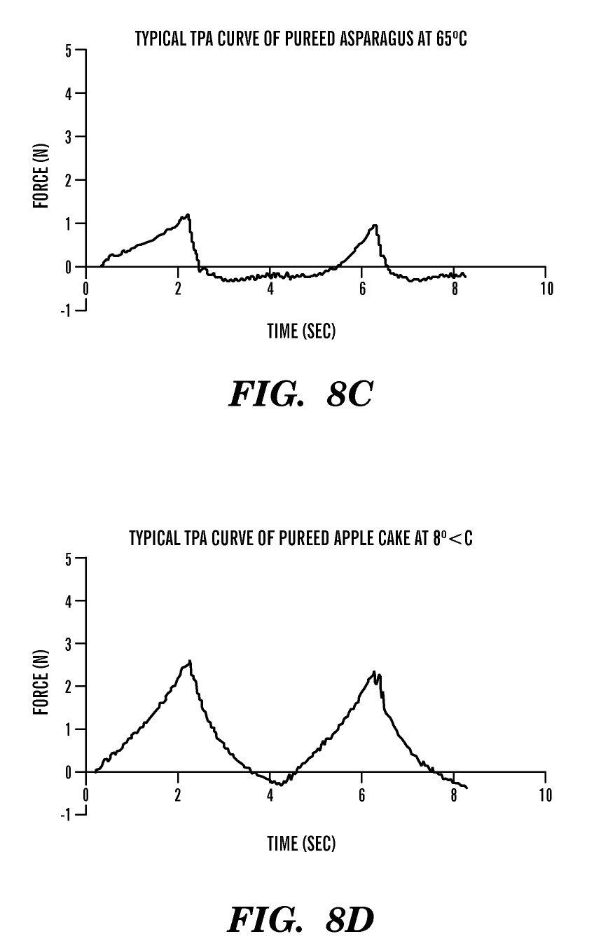

FIGS. 8a to 8d show typical TPA curves for minced beef, pureed beef, pureed asparagus and pureed apple cake.

Generally texture profile analyses are done on products of the same type as for cheeses or specific beef meats profiling. In this study, various types of meats or vegetables or cakes were grouped together to form a group of minced or pureed products in order to provide a clinical answer to dysphagia. The variability normally found in studies of food samples of the same products was potentially enhanced by the presence of several types of food. It is also important to mention that the food items in those food groups were representative of only one production batch. Since these products are made manually and have little automation in the process, it is possible that the variability was increased by handling.

When discussing dysphagia diets, several authors will refer to softness and the tenderness of the food items offered on the menu. It is actually intended to describe foods of reduced firmness. This mechanical characteristic could be quantified using the Texture Profile Analysis (TPA). The TPA will provide a first value of firmness (Firmness 1) which corresponds to the initial force required to first compress the food and a second firmness (Firmness 2) is obtained on the second portion of the compression cycle. The second firmness value will indicate the force required to compress the same sample a second time (second bite). Ultimately, for dysphagic individuals, the initial force required to chew or to manipulate the food in the mouth should be kept to a minimum in order to limit the fatigue that could result from the eating activity. The pureed reshaped vegetables and fruits showed a Firmness 1 of 0.385 to 2.105 Newtons (N), the reshaped minced meat present a Firmness 1 of 1.007 to 11.086 N, the reshaped pureed meats had a Firmness 1 0.643 to 5.038N and the pureed cakes at 23° C. displayed a Firmness 1 of 0.951 to 2.835N while the cakes at 8-12° C. showed a firmness of 0.500 to 7.202 N.

A low firmness 2 (firmness sensed at the second compression) should be seen as important since it could imply that the first compression of the food was successful and the food item required less chewing.

Firmness 1 and firmness 2 are integrated into the cohesiveness ratio. In fact, cohesiveness is the result of the ratio of the firmness 2 by the firmness 1. A low cohesiveness ratio indicates that the first compression had strongly damaged the macro-structure of the food and that the following compression encountered much less resistance the second time down on the food. Clinically, a low cohesiveness ratio could imply the initial macro-structure of the food is greatly affected by the first compression therefore less energy will have to be deployed by the patient, on the second compression, to transform the food into a cohesive and ready-to-swallow bolus. The pureed reshaped vegetables and fruits presented a cohesiveness of 0.146 to 0.411, the reshaped minced meat had a cohesiveness of 0.105 to 0.388, the reshaped pureed meats had a cohesiveness 0.147 to 0.448 and the pureed cakes at 23° C. displayed a cohesiveness of 0.202 to 0.499 while the cakes at 8-12° C. displayed a cohesiveness of 0.095 to 0.590.

Springiness is the capacity of a solid to go back to its original shape after a force has been applied. For dysphagic individuals, springiness should be maintained to a minimum considering that the energy required to chew should be kept to a minimum. A food having great springiness would bounce back to its original shape, requiring many strokes of the jaw before being appropriate in texture to swallow. The group of foods presenting the lowest springiness level is the pureed vegetables and fruits at 0.980 to 8.182% followed by the minced meats and the pureed meats with 1.324 to 24.416% and 1.152 to 13.729%, respectively. The pureed cakes at 23° C. displayed a springiness of 4.297 to 39.584%. The group presenting the highest springiness of all is the pureed cakes category at 8-12° C. with 3.330 to 62.505%.

Another mechanical rheological parameter to be considered when developing foods for dysphagic individuals is adhesiveness. Adhesiveness corresponds to the force or energy necessary to break the attraction of the foods with the structures of the mouth (teeth, palate, tongue, etc.). For dysphagic individuals, food items presenting high adhesiveness such as peanut butter should be avoided. Diminished tongue motion and mouth sensitivity will reduce the capacity of the patient to clean food particles clinging to the mouth's structures. When the results of the adhesiveness parameter are evaluated, it is observed that the reshaped pureed vegetables and fruits present the least adhesiveness with a sensed resistance force of 0.206 to 0.781 mm. The reshaped minced meats and the reshaped pureed meats present an adhesiveness of −0.199 to −1.212 mm and −0.373 to −1.459 mm respectively. The reshaped pureed cakes at 23° C. displayed an adhesiveness in the range of −0.148 to −1.518 mm. The reshaped pureed cakes 8° C.-12° C. have the highest adhesiveness with −0.383 to −1.601 mm.

Chewiness, the product of firmness, cohesiveness and springiness, is the force required to reduce a solid to a ready-to-swallow bolus. Although these products are soft solids, the chewiness—the force necessary to reduce a solid product to a ready-to-swallow bolus—remains a factor of interest. In fact, if chewiness became too important, the re-shaping of the reshaped foods might be harmful. The pureed vegetables and fruits showed 0.095 to 5.911N for the chewiness parameter. The minced meats and the pureed meats demonstrated chewiness values of 0.410 to 28.607N and 0.470 to 15.819N. Cakes at 23° C. displayed chewiness values in the range of 1.724 to 26.553N. The reshaped pureed cakes 8° C.-12° C. present the highest chewiness with 0.422 to 197.513N.

The reshaped foods are soft foods and could be considered as semi-solids. Therefore, the gumminess, the product of firmness and cohesiveness, was also a rheological parameter evaluated. This last parameter evaluated the force required to reduce a semi-solid to a ready-to-swallow bolus. Here again, the pureed vegetables and fruits show the least gumminess with a value of 0.086 to 0.788 N. Minced meats and pureed meats had a gumminess value of 0.205 to 3.776 N and 0.122 to 1.724 N, respectively. The pureed cakes at 23° C. displayed gumminess values of 0.320 to 1.295N while the pureed cakes at 8° C.-12° C. displayed a gumminess of 0.064 to 3.729 N.

The cakes are generally used with the reshaped pureed meats and reshaped pureed vegetables as part of the Pureed diet. The discrepancy was questioned further. The reshaped pureed cakes were evaluated at a temperature of 8° C. which was believed to be the optimal serving temperature. A potential explanation for these high springiness values is the presence of a cold-stable binder in the formulations of the cakes. Therefore, it is possible that TPA values obtained at 8° C. would generate high springiness values. Also, it was observed that the cakes remained in the patient tray for a certain amount of time—closer to room temperature—before the reshaped Pureed cake is eaten. It is possible that a TPA performed at such temperatures would generate lower springiness values due to a softening of the binder at higher temperature.

This evaluation granted objective and quantified results on 7 mechanical texture parameters (firmness at the first bite, firmness at the second bite, cohesiveness, adhesiveness, springiness, chewiness, gumminess) at optimal serving temperatures for reshaped minced meats, reshaped pureed meats, reshaped pureed vegetables and reshaped pureed cakes.

### Example II

### Randomized Clinical Trial

### Introduction

Given the high prevalence of dysphagia and malnutrition in the institutionalized elderly population and the limited information concerning the clinical efficacy of the various dysphagia diets, a randomized clinical study was planned by Saint-Anne's Hospital (SAH). The goal of the study was to evaluate the impact of the SAH's reshaped modified texture foods and thickened beverages on the dietary intake and health of dysphagic frail elderly.

Therefore, an investigation took place from June 1999 to December 1999 at Marie-Rollet Center (MR), a Quebec Long Term Care Facility of the Montreal region. This was a 12-week randomized clinical trial where dysphagic individuals with a recent history of weight loss and/or low BMI were randomly assigned to an experimental or a control group. After an evaluation of their swallowing ability, the subjects of the experimental group were provided with SAH reshaped foods and thickened beverages whereas the control group continued receiving the menu offered at MR. Food intake, weight, BMI, number and type of prescriptions, presence of pressure ulcers and development of other infections were monitored for both groups.

The following section will provide the results and discussion resulting from this trial.

The goal of this randomized clinical trial was to improve the dietary intake in dysphagic frail elderly as a mean of improving health. Two objectives were also established for this investigation:

a) To assess whether a change in dietary intake will occur, over a period of 12 weeks, in dysphagic frail elderly receiving SAH's dysphagia diet and Marie-Rollet modified texture diet.

b) To measure weight changes and compare both groups as a result of the consumption of these 2 diets.

### Methods

### Subject Selection

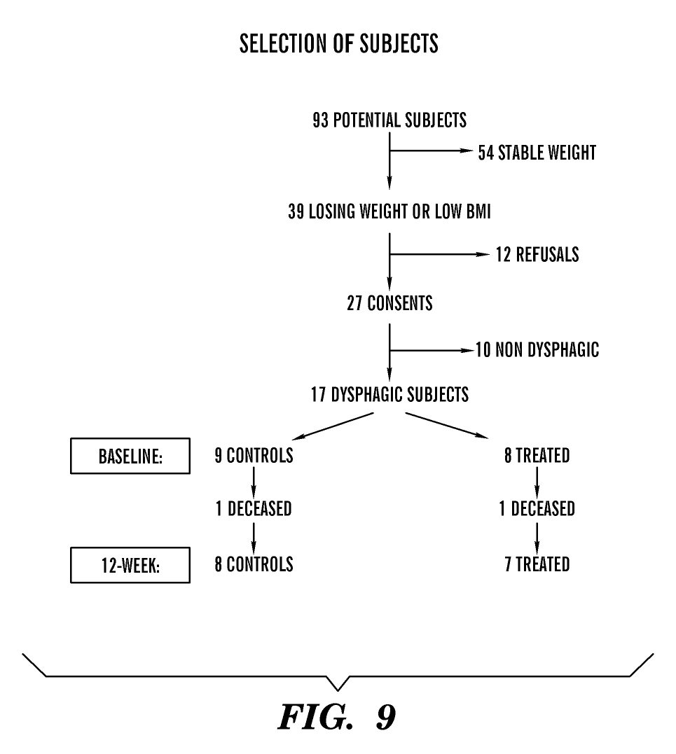

Marie-Rollet Long Term Care Center (MR) is a Quebec long-term care facility where 93 elderly individuals and 32 young adults with important physical handicaps reside (FIG. 9). Individuals between 60 and 90 years of age who had been at the Center for more than 3 months and suffered an involuntary weight loss >7.5% of usual weight in the past 3 months or presented BMI of less than 24 were considered potential candidates to included in the protocol. Type of diet and diet consistencies were not exclusive. Individuals with an active cancer, a chronic intestinal disease such as Crohn Disease or in agony were excluded. Also, individuals who would have required an amputation during the course of the protocol would have been excused.

All 93 medical files of the geriatric population at MR were evaluated to determine which patients corresponded to the inclusion criteria. Two previous weight recordings—usually taken every two months for each individual at MR—and the height of each subject were obtained from the medical charts. The two last weights noted in the charts were compared and the change in weight was calculated.

The bedside evaluation for dysphagia was done using the RIC Clinical Evaluation of dysphagia to confirm the presence of oro-pharyngeal dysphagia. Subjects who were alert enough to participate were observed in their room. Pre-feeding skills, dentition status, phonation and volitional cough were assessed. Positioning was observed. Patients were asked to drink water, eat vanilla commercial pudding and chew on a graham crackers, in a pre-determined order. They were evaluated for oral and pharyngeal stages of the swallowing process. Dysphagia was identified when an individual presented difficulties eating or swallowing solids or liquids.

### Randomization

This was a randomized clinical trial of two treatments at Marie-Rollet long-term care center. The allocation of the subjects to the experimental (reshaped foods and thickened beverages supplied by SAH) or control group (Marie-Rollet traditional foods) was done according to a predetermined randomization protocol. Thirty envelopes containing either a Treatment or a Control label were prepared, sealed and numbered. The sequence of group allocation was unknown to the dietitian performing the screening evaluations. As subjects were positively screened for dysphagia, they received the next study number and the corresponding envelope was opened. The subjects were then allocated to the specified group. FIG. 9 presents the allocation of the subjects to the groups.

### Measurements

Weights were recorded in the charts every two months for most patients. Height and smoking status were present in either Social and Physical Evaluation chart (CTMSP) or in the initial medical evaluation. Medications were usually prescribed for an approximate 3 month-period (105 days) and adjusted as needed. Nursing staff would amend the medical chart when a change in medication took place. The prescription data were computerized which ensured legibility. The dietitian noted every intervention on the Dietary Services form and completed the report deriving from in the annual multi-disciplinary evaluation of the patients. No biochemical data were gathered for this study.

During the course of the study, variation in medical status, absence/presence or evolution of pressure ulcers and development of infections were documented daily in the medical charts by the nursing staff and/or by the doctor responsible for the ward.

At baseline, medical assessment information such as age, principal diagnosis, height, smoking status (prior and current) was collected. When a subject presented more than one diagnosis, the diagnosis leading to institutionalization was retained as the primary diagnosis.

The nursing staff was instructed to weigh subjects with interior clothes and without shoes on a pedestal scale. Individuals who could not stand were weighed on a scale lift or on a chair scale. For the latter, the weight of the chair was subtracted subsequently. For individuals with incontinence, the diaper had to be new. At weeks 6 and 12, subjects were weighed again according to the protocol.

Heights from the charts were confirmed by knee height measurements. The knee height measurement was obtained by using the Ross Caliper. The subjects were lying on their back, the left knee and ankle were bent at a 90° angle. The fixed band of the caliper was placed under the heel whereas the mobile band was placed on the thigh, 5 cm from the patella. Each subject was measured for height twice (results had to be within 0.5 cm otherwise a third measure was obtained when needed). The average of the two nearest values, within 0.5 cm, obtained by knee-height measurements was used for the study. BMI was calculated by dividing weight (kg) by the value of the height-squared (m²).

Two-day dietary intakes were measured at baseline at mid- (6 weeks) and end- (12 weeks) points. The same days of the menu cycle were evaluated to facilitate the comparative analysis and to limit the variation due to food diversity alone. The dietary intakes were completed by the dietitian in charge of the project for both groups. Each item served on the trays for these 2 days was weighted before and after the service of the meal. Differential weights (before and after) of each container were considered to be the eaten portions. The trays were also marked with a special reminder card to insure that nothing was mistakenly thrown away and that all empty containers were kept.

When items were stirred together (meat, potato and the sauce for example), the weight of the remaining portion was evaluated according to a pro-rata ratio as compared to the original quantity of each food items served (weight of the meat, the potato and the sauce). The subtraction was performed and the nutritional value was calculated for each item accordingly. When the original weight of each item was not available, as for the Campbell™ TrePuree's meat, vegetable and potato fractions for example, the remaining portion was considered as a fraction of the original total weight. The nursing staff listed snacks. The 2-day dietary intakes were repeated at week 6 and week 12.

Dietary analyses were performed by the NUTRIWATCH™ Software package (NUTRIWATCH, Nutrient Analysis Program, Version 6.1.4F—Delphi 1 for Windows, 2000, PEI, Canada). Nutritional values absent from the Canadian food file were manually entered following the values provided by the manufacturer whenever possible. Nutrient composition of certain recipes were also added to the Canadian food files according to existing recipes at SAH and MR Center for items such as thickened soups, salmon pie and shepherd's pie. The laxative puree (prune/bran cereal mixture) offered daily at MR was prepared on site and the recipe was added to the Canadian Food File. The quantity of laxative puree received by each patient was entered in the nutrient analysis program as indicated on the prescription chart.

On both days of dietary intake, the dietitian in charge of the project monitored the time required to complete the breakfast, lunch and supper meals. The feeder was also identified as being an orderly, the patient or a family member.

### Intervention

To help in feeding individuals with oro-pharyngeal dysphagia to solids, the texture of the foods offered to the patients had to be altered. Individuals could suffer—independently of their capacity to handle solid foods—from oro-pharyngeal dysphagia to liquids. When dysphagia to liquids was identified, patients received beverages modified for their consistency: thickened beverages.

The 3 week-cycle menu was maintained and the modification of the texture was adjusted, when needed, according to the bedside assessment results (RIC Evaluation of Dysphagia) and the clinical evaluation of the dietitian at MR. It would have been unethical to maintain a diet consistency believed to be inadequate considering the dysphagia evaluation results. All subjects continued to receive their MR menus and remained under the care of the dietitian on duty 2 days a week at the Center.

### Intervention Related to the Control Group

The menus were computerized according to the patients' nutritional needs, specific diet, allergies, preferences, and aversions on MICROGESTA SOFTWARE™. The MICROGESTA SOFTWARE™ was programmed with a menu of 21 days which was fragmented into different choices according to various diet profiles required (diabetic, no salt added, high fiber, soft, etc.). The diet prescription of each patient was identified with a code and the system took into consideration the likes and dislikes of the patient, previously entered by the clinical dietitian. The menu was then generated by deduction by the software according to the preset menu items. In general, the menu could be presented as follows: 1 soup was offered daily in its regular consistency and a thickened version (E.g.: chicken noodle soup and thickened and blended noodle soup); 1 choice of main dish, different for each meal; 3 alternative items À la carte were also available at each meal: sliced ham, hamburger steak or sandwiches; 2 choices of vegetables were offered at each meal but only one was modified in texture (E.g.: broccoli and pureed carrots); 4 choices of desserts were available at lunch and dinner. They included normal texture items such as cakes and canned fruits and more soft texture choices such as ice cream and puddings. The menu cards were printed periodically and used to assemble the tray according to the patients' needs.

At MR, modified textured diets were of three types: Minced 70, Minced 3 and Pureed diet. Cooks at MR prepared the minced foods. The Minced 70 diet allowed all minced foods—originating from the regular texture diet menu (E.g.: Minced salmon pie) to be offered to the patients. It also offered certain soft foods such as meat loaf, poached fish, muffins and omelets. The soft desserts such as soft cakes without nuts, mousse cakes or firm yogurts were also permitted for these patients. The Minced 3 diet was used to identify the diet where all the foods—again derived from the regular texture diet menu—were presented on a minced form to the patient (meats, stews, pasta and vegetables) or softer texture such as pureed foods (pureed fruits and puddings). No soft foods were included. The Pureed diet consisted of mainly CAMPBELL® TREPUREE™ foods as main entrees and desserts and other foods offered were of the pureed texture. This dish comprises the pureed meat, vegetable and potato in three parallel ‘sausage-looking’ portions. The dishes come in an assortment of 12 pre-determined menus. The pureed diets also offered traditional pureed foods (Pictures 1-5, FIG. 15).

MR offered one level of thickened consistency beverages designated Honey. The beverages were prepared using a commercial instant thickening agent named CONSISTAID™ (BERTHELET®, Montreal, Canada), 24 hours before service. A description of this consistency would be that it was almost as thick as a commercial pudding; it did not flow readily when poured. The consistency did not compare to SAH's ‘Honey’ consistency as it was more similar to SAH's consistency named ‘Pudding’. No other consistency was available. Although the recipes were standardized, the consistency obtained sometimes varied with production due to production changes (measurements of ingredients, type of ingredients, etc.). The consistency was not systematically controlled. Six varieties of thickened beverages were offered at MR: apple juice, orange juice, cranberry juice and tropical juice, 2% milk or vanilla supplements. The daily production schedule for the thickened beverages offered 2 types of juices along with milk and vanilla supplement.

### Intervention Related to the Experimental Group

For the duration of the study, the nutritional care of the subjects in the treated group was shared by the 3 clinical-dietitians from Sainte-Anne's Hospital. They were instructed to use SAH's nutritional approach to care for the nutritional needs of the treated group. The dietitian in charge of the project was responsible for transmitting the daily information concerning each patient and insuring meal delivery.

SAH's nutritional approach is highly individualized and aimed at using foods dense in energy, SAH's reshaped foods (pureed fruits, vegetables and deserts along with pureed and minced meats), thickened beverages as pertinent, and supplements when necessary. The SAH enriched-milk (milk added of skimmed milk powder) was also available.

The menus were revised for each subject of the treated group. Two subjects were able to inform us of their food preferences and dislikes. Their menus were adapted accordingly. The MICROGESTA SOFTWARE™ did not allow the inclusion of SAH ‘à la carte’ items. Therefore, to reduce perceivable changes on the tray and possible bias, 63 menu cards (3 meals×7 days×3 weeks) were reproduced using MICROSOFT® EXCEL Software for each treated subject to match the menu cards usually printed for MR patients.

SAH also offered three types of modified texture diets: Minced diet, Minced/Pureed diet and Pureed diet. For the Treated group, the SAH's reshaped foods were introduced and a new 3-week cycle menu was developed. This new menu reflected the regular texture menu normally offered at MR.

The new selection offered a variety of 9 reshaped meats in minced or pureed texture (beef, veal, ham—cold or hot—and turkey slices, chicken breasts, pork and lamb chop), 5 cube-shaped dishes in minced or pureed texture (Stroganoff Beef, Soukiaki Beef, Bourguignon Beef, Vegetable Stew and Fall Stew) and 3 reshaped dishes in pureed texture only (meat pie, salmon pie and lasagna). Nine vegetables were also available in the reshaped shapes. The selection of vegetables included baby carrots, asparagus, waxed beans, green beans, broccoli, cauliflower, green peas, cold salad and cold marinated beets.

Reshaped desserts were offered mainly as cakes or fruits. The cakes were shaped as a disc of approximately 1-inch of height and always dressed with either fruit sauce or whipped toppings. The cakes made available were carrot cake (cheese topping), peach cake (peach sauce), apple cake (applesauce), choco-moka cake (vanilla whipped topping), Bagatelle cake (cranberry topping), vanilla cake (chocolate whipped topping), chocolate cake (vanilla whipped topping) and Black Forest cake (vanilla whipped topping). The fruits included reshaped quarters of peaches, half pears, strawberries and pineapple slices. Other soft desserts such as puddings and applesauce were available and offered as patients' tolerance and acceptability permitted.

At each meal, the patient had a choice of 2 types of reshaped meats (menu of the day or a substitute), 2 reshaped vegetables and a choice of reshaped cake and/or reshaped fruit and other regular items when possible for their condition. The overall menu followed the 3-week-menu already offered at MR as closely as possible. If these choices were not to their liking, the patient could receive an item from the À la carte menu that remained the same daily: reshaped pork cutlet, reshaped beef or ham slices and pureed sandwiches (egg and ham).

SAH's thickened beverages were offered in their 3 consistencies named Nectar, Honey and Pudding. (Picture 4). The recipes were standardized and the products were controlled at SAH using the BOSTWICK™ consistometer to insure conformity to pre-established standards as part of the regular Q/A assessments. When a batch did not meet the standard, the production team was made aware of the problem and the thickened beverages were corrected. If a beverage did not meet the standard after the re-evaluation of the batch, it was discarded. The selection of SAH's thickened beverages included thickened milk, milkshake, vanilla, chocolate, strawberry or banana supplements, apple, orange, prune and cranberry juices.

### Providing SAH's Foods to MR

The reshaped foods (main dish plates, desserts) and thickened beverages and supplements were assembled at SAH by kitchen staff, following a compilation order, and delivered daily (Monday through Friday) in a cart using the SAH's patient transportation bus in a Cambro isothermal-cart. The cart was left at the reception desk at MR at 7:00 AM and was then send to the walk-in refrigerator soon after. Each individually labeled item was refrigerated until serving time on an pre-identified tray, rethermalized for 45 minutes in a Combi-Oven by SAH staff and served at the same time and with the same equipment usually used at MR to deliver the trays. One extra plate was heated at every meal to assure conformity and quality control for temperature, texture and appearance. The menu cards were reproduced to match the original ones to limit the influence of the overall tray aspect. The diet texture was highlighted with a yellow marker to ease the recognition of these plates and allow for proper service.

### Statistical Methods

The data obtained at baseline were compared using unpaired Student's t-test to assess any difference between the groups at Baseline. This procedure was repeated with the data gathered at week-6 and week-12. An assessment of change over time was done to measure the change in nutritional intake (paired t-test) (Table 6). The change in weight and dietary intake from baseline to midway evaluations and from baseline to final assessments was compared between the groups using Student's unpaired t-test. Data analysis was completed using the SAS software package (SAS, version 6.12 for Windows). Probability of p<0.05 was considered as statistically significant.

### Results

### Screening and Evaluations

The evaluation of the medical charts identified 39 individuals fitting our inclusion criteria (39/93; 41.9%) and for whom consent was requested. In total, 27 consents were obtained (27/39; 69.2%). Of these, two consents were obtained from the Quebec Curator (2/27; 7.4%; 100% of the requested list). 24 consents (24/27; 88.8%) were obtained by family members or the individual responsible for the individuals i.e. the legal proxy. They had been contacted by the head nurse of each ward. One (1) consent (1/27; 3.7%) was obtained from a resident capable of providing consent. Seventeen individuals (17/27; 63%) were identified as being dysphagic and included in the protocol. The remaining 10 subjects were not dysphagic according to the bedside RIC Clinical Evaluation of dysphagia and were at a low BMI or losing weight for other reasons not investigated here (FIG. 9).

TABLE 6
Levels for Changes in Nutrient Intake in Treated and Control Subjects

| | Baseline versus | | Baseline versus | |
|---|---|---|---|---|
| | Week 6 | | Week 12 | |
| | Treated | Controls | Treated | Controls |
| Variables | P-Value | P-Value | P-Value | P-Value |
| NB Prescriptions | <0.01 | | | |
| Weight | | | <0.01 | |
| BMI | | | <0.01 | |
| Energy | <0.01 | | <0.05 | |
| Protein | <0.01 | | <0.05 | |
| Carbohydrate | <0.05 | | <0.05 | |
| Lipid | | | <0.05 | |
| Cholesterol | <0.05 | | | |
| Total Fiber (g) | | | | |
| Sodium | <0.05 | | | |
| Potassium | <0.05 | | <0.05 | |
| Magnesium | <0.01 | | <0.05 | |
| Calcium | <0.01 | | <0.01 | |
| Phosphorus | <0.01 | | <0.01 | |
| Iron | | | | <0.05 |
| Zinc | <0.05 | | <0.05 | |
| Carotene | | | | |
| Vitamin A | <0.05 | | | |
| Vitamin C | | | | |
| Vitamin D | <0.01 | | <0.01 | |
| Vitamin B₃ | <0.05 | | | |
| Vitamin B₂ | <0.01 | | <0.01 | |
| Vitamin B₁ | <0.05 | | <0.05 | |
| Vitamin B₆ | <0.05 | | | |
| Vitamin B₁₂ | <0.01 | | <0.05 | |
| Ac. Pantotenic | <0.05 | | | |
| Folacin | <0.05 | | | |
| Total Saturated Fat (g) | <0.01 | <0.05 | <0.01 | |
| Monounsaturated Fat (g) | <0.05 | | <0.05 | |
| Polyunsaturated Fat (g) | | | | |
| Vitamin E | <0.05 | | <0.05 | |
| Copper | | | | |
| Manganese | | | | |

Reasons for refusal to participate in the study included: 1) the family members or the proxy could not be reached during this time of the year—summer season; 2) family members were unsure of the necessity of their loved ones participating in such a study, therefore they refused; 3) competent patients refused to see their menu modified or to undergo the screening evaluation for dysphagia.

The random assignment of the 17 dysphagic individuals resulted in the allocation of 8 patients (3 men) to the treatment group whereas 9 patients (4 men) were assigned to the control group. The medical profile of the subjects was similar in both groups where principal diagnoses were Alzheimer's Disease (Controls: 55.6% and Treated: 37.5%) and Dementia (Controls: 22.2% and Treated: 50%). No one needed tube feeding or amputation. No statistical difference was observed when we compared both groups for sex, age and smoking status. Table 7 describes the principal characteristics studied for each group.

TABLE 7
Principal Characteristics for the Individuals Entering
the Protocol (Baseline Values)

| | Control Group | Treated Group | |
|---|---|---|---|
| Characteristics | (n = 9) | (n = 8) | p-Value |
| Number of females | 5 | 5 | |
| Time post admission (Years ± | 4.8 ± 1.90 | 3.9 ± 1.66 | |
| SD) | | | |
| Age (Years ± SD) | 84.6 ± 3.81 | 82.5 ± 4.41 | 0.3186 |
| Weight (kg ± SD) | 54.3 ± 7.49 | 55.9 ± 12.09 | 0.7434 |
| BMI (kg/m² ± SD) | 22.4 ± 3.93 | 21.2 ± 2.31 | 0.4471 |
| Primary Diagnostics | | | |
| Alzheimer's Disease | 5 (55.6%) | 3 (37.5%) | |
| Parkinson's Disease | 1 (11.1%) | 0 (0%) | |
| Other dementias | 2 (22.2%) | 4 (50%) | |
| Stoke | 1 (11.1%) | 1 (12.5%) | |
| Number of Prescriptions | 5.0 ± 2.55 | 8.6 ± 5.07 | 0.0772 |
| Number of smokers | 0 | 1 | |

No statistical difference was noted when comparing the baseline parameters of both groups

### Participation Ratio and Prevalence of Malnutrition and Dysphagia

After the screening, 17 of the 39 individuals (43.5%) were found to be dysphagic. This is not a true prevalence of dysphagia since the pre-screening and consent process potentially eliminated certain dysphagic individuals who were not losing weight, were at a BMI >24 or who refused to participate in the study.

### Pre-Protocol Dietetic Prescriptions

Before the bedside evaluation for dysphagia was performed, 1 individual was receiving a Pureed diet with thickened beverages and 2 subjects were receiving the Minced-70 diet with thickened beverages. Two individuals were on the Pureed diet, 1 individual was on the Minced-3 diet, 9 individuals were on the Minced-70 diet and 2 individuals received the Regular texture diet (Table 8).

To insure that subjects in both groups were receiving the texture most adapted to their physical capacity, modifications of the texture of the foods and the consistency of the beverages were done according to the results of the dysphagia screening evaluation for all subjects. The results of the oro-pharyngeal evaluations for dysphagia led us to suggest modifications for food texture or beverage consistency for 4 individuals in the control group and 1 individual in the treated group. This approach was used to diminish the possible impact of having individuals in either group who would receive a diet that was not adequate for their needs.

TABLE 8
Diet Prescriptions Prior and During the Protocol Period

| | | | | | | | | | |
|---|---|---|---|---|---|---|---|---|---|
| Control Group | Pureed | Minced 3 | Minced 70 | Regular | Treated Group | Pureed | Minced 3 | Minced 70 | Regular |

Pre-Protocol Diet Prescription

| | | | | | | | | |
|---|---|---|---|---|---|---|---|---|
| Clear liquids | 2 | 5 | 1 | Clear liquids | | 1 | 4 | 1 |
| Nectar liquids | | | | Nectar liquids | | | | |
| Honey liquids | | 1 | | Honey liquids | 1 | | 1 | |
| Pudding liquids | | | | Pudding liquids | | | | |

First Dietary Intake Evaluation

| Clear liquids | 3 | | 2 | 1 | Clear liquids | | 1 | 4 | 1 |
|---|---|---|---|---|---|---|---|---|---|
| Nectar liquids | | | | | Nectar liquids | | | | |
| Honey liquids | 2 | | 1 | | Honey liquids | 1 | | 1 | |
| Pudding liquids | | | | | Pudding liquids | | | | |
| | | | | | | P/F | MP/F | | |
| Control Group | Pureed | Minced 3 | Minced 70 | Regular | Treated Group | HSA | HSA | M/F HSA | Regular |

Midway Dietary Intake Evaluation

| | | | | | | | | |
|---|---|---|---|---|---|---|---|---|
| Clear liquids | 3 | 2 | 1 | Clear liquids | 1 | 1 | 4 | |
| Nectar liquids | | | | Nectar liquids | | | | 1 |
| Honey liquids | 2 | 1 | | Honey liquids | | | | |
| Pudding liquids | | | | Pudding liquids | 1 | | | |

Final Dietary Intake Evaluation

| | | | | | | | | | |
|---|---|---|---|---|---|---|---|---|---|
| Clear liquids | 1 | 1 | 1 | 1 | Clear liquids | 2 | 2 | 2 | |
| Nectar liquids | | | | | Nectar liquids | | | | 1 |
| Honey liquids | 2 | | 2 | | Honey liquids | | | | |
| Pudding liquids | | | | | Pudding liquids | | | | |

### Baseline Characteristics

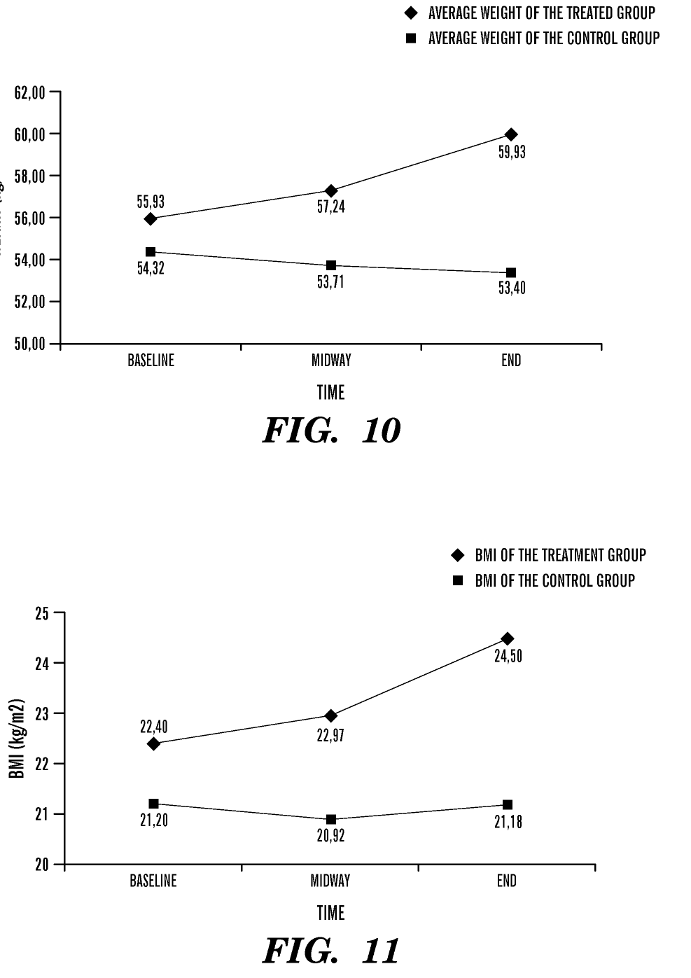

The average weight of the control group was 54.3±7.49 kg whereas the average weight for the treated group was 55.9±12.06 kg (FIG. 10). The average BMI values for the treated group was 22.4±3.93 kg/m² and for the control group 21.2±2.31 kg/m². Both groups had mean BMI values below the 24 value desired for a geriatric population (FIG. 11).

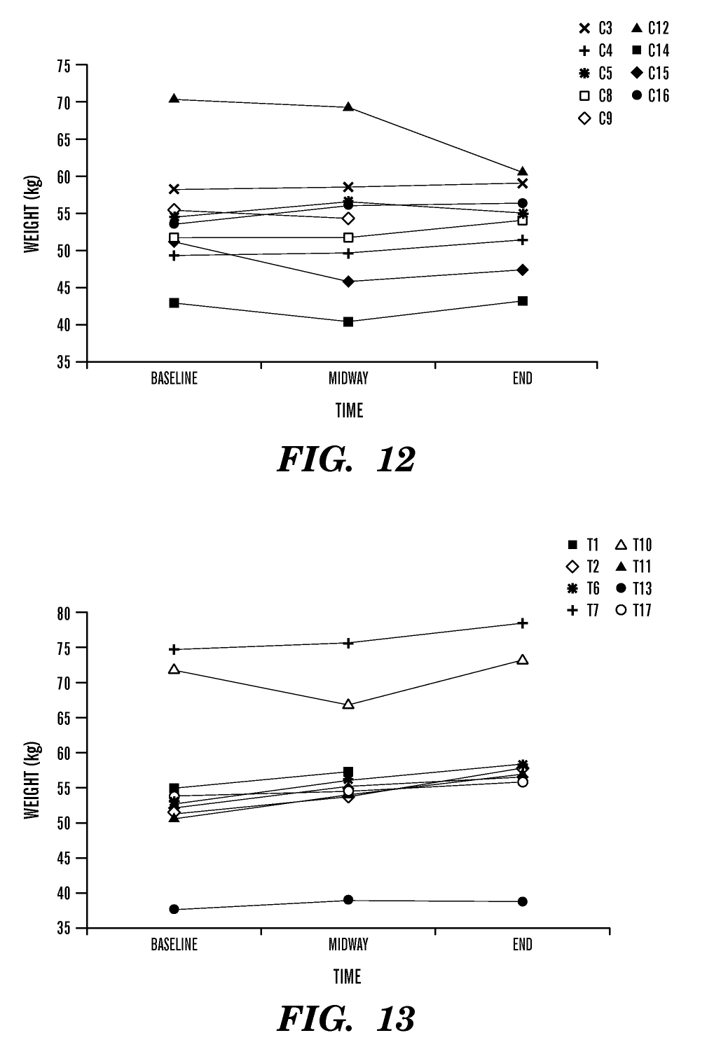

The high variability noted could be explained by the presence of both males and females in each group and the heterogeneity of the geriatric population. When the data is considered more closely, we can see that 2 individuals in the treated group and 1 subject in the control group were above the Canadian recommended weight values for individuals over 75 years of age which are 64 kg for women and 69 kg for men (FIGS. 12 and 13).

The analysis of the dietary intakes revealed no statistical difference between the subjects of both groups (Table 9). At baseline, the treated group had an initial intake of 5748±985 kJ (1374±235 kCal) whereas the control group received 6551±1352 kJ (1566±323 kCal). We can see a high variability in energy intake, which could be explained by the heterogeneity of the health status and appetite of these geriatric patients. Although both groups are similar for energy intake, it is important to mention that the Nutrition Recommendations of Health Canada for the energy intake of the healthy individuals, presenting a low activity level, in the age group of 75 and over is of 7113 kJ (1700 kCal) for women and 8368 kJ (2000 kCal) for men. Therefore, both group averages are below the recommended values. When the individual data of the dietary intake are considered, we could see that only two individuals of the control group surpassed the suggested energy intake.

In addition, according to the Nutrition Recommendations of Health Canada, the average energy requirements for elderly individuals should be approximately 33 kCal per kilogram. The energy intakes observed at baseline were 24.6 kCal/kg and 28.8 kCal/kg for the treated group and the control group, respectively.

TABLE 9
Energy Intake and Nutrient Composition of the Groups
at the Baseline Assessment

| | | | Treated Group | | |
|---|---|---|---|---|---|
| | Control (n = 9) | | (n = 8) | | t-test |
| Variables | Mean | SD | Mean | SD | p-Values |
| Weight (kg) | 54.30 | 7.50 | 55.90 | 12.10 | 0.7434 |
| Number of | 5.00 | 2.50 | 8.60 | 5.00 | 0.0772 |
| Prescriptions | | | | | |
| BMI | 21.19 | 2.30 | 22.39 | 3.90 | 0.4471 |
| Energy (kJ) | 6551 | 1352 | 5748 | 985 | 0.1864 |
| Protein (g) | 55.97 | 16.84 | 52.49 | 14.63 | 0.6574 |
| | (14%) | | (15%) | | |
| Carbohydrate (g) | 238 | 45.17 | 211.07 | 23.40 | 0.1466 |
| | (59%) | | (59%) | | |
| Lipid (g) | 47.41 | 13.66 | 39.29 | 12.16 | 0.2177 |
| | (27%) | | (26%) | | |
| Cholesterol (mg) | 131.00 | 70.84 | 123.20 | 15.38 | 0.7912 |
| Total Fiber (g) | 16.92 | 6.78 | 12.63 | 4.68 | 0.1553 |
| Sodium (mg) | 2518.56 | 623.88 | 2580.19 | 819.78 | 0.8629 |
| Potassium (mg) | 2885.06 | 624.86 | 2703.88 | 636.92 | 0.5631 |
| Magnesium (mg) | 255.67 | 50.78 | 239.63 | 76.17 | 0.6129 |
| Calcium (mg) | 757.06 | 209.40 | 638.75 | 312.30 | 0.3683 |
| Phosphorus (mg) | 1107 | 251 | 975.31 | 298.88 | 0.3382 |
| Iron (mg) | 13.47 | 4.97 | 12.15 | 2.84 | 0.5199 |
| Zinc (mg) | 8.88 | 3.50 | 7.90 | 4.16 | 0.6061 |
| Carotene (RE) | 136.33 | 116.87 | 166.81 | 258.13 | 0.7654 |
| Vitamin A (RE) | 1150.22 | 386.51 | 1338.69 | 531.12 | 0.4121 |
| Vitamin C (mg) | 155.28 | 51.38 | 136.44 | 74.89 | 0.5503 |
| Vitamin D (μg) | 4.45 | 1.81 | 3.39 | 2.46 | 0.3230 |
| Vitamin B₁ (mg) | 1.63 | 0.74 | 1.39 | 0.58 | 0.4638 |
| Vitamin B₂ (mg) | 1.93 | 0.97 | 1.38 | 0.47 | 0.1623 |
| Vitamin B₃ (NE) | 22.31 | 6.54 | 22.93 | 7.52 | 0.8582 |
| Vitamin B₆ (mg) | 1.36 | 0.33 | 1.53 | 0.60 | 0.4845 |
| Vitamin B₁₂ (μg) | 2.57 | 1.39 | 2.82 | 1.49 | 0.7298 |
| Pantothenic Acid (mg) | 4.53 | 1.42 | 3.80 | 1.56 | 0.3314 |
| Folacin (μg) | 192.89 | 60.98 | 175.66 | 70.55 | 0.5967 |
| Total Saturated Fat (g) | 11.29 | 4.95 | 11.69 | 6.03 | 0.8828 |
| Monounsaturated | 10.80 | 4.87 | 13.18 | 7.46 | 0.4429 |
| Fat (g) | | | | | |
| Polyunsaturated | 5.84 | 2.67 | 6.72 | 3.39 | 0.5605 |
| Fat (g) | | | | | |
| Vitamin E (mg) | 2.22 | 1.04 | 1.62 | 0.92 | 0.2313 |
| Copper (mg) | 0.98 | 0.25 | 1.01 | 0.40 | 0.8581 |
| Manganese (mg) | 3.17 | 1.22 | 2.75 | 1.20 | 0.4898 |

Initially, the macronutrient intake were as follows for the control group: 14% of energy was obtained from proteins, 60% of energy from carbohydrates and 27% of energy from lipids. For the treated group, the macronutrients intake was similar: 15% from proteins, 60% from carbohydrates and 26% from lipids. These results showed no statistical differences between the groups but inform us that both groups were receiving a well balanced diet at baseline.

Proteins are important to maintain the integrity of the immune system and in preventing or improving skin damage such as pressure ulcers. The baseline evaluations of the dietary intakes show that the treated group received a daily average of 52.5 g±14.6 g of proteins (0.97 g/kg per day) and that the control group consumed 56.0 g±16.8 g of proteins (1.00 g/kg per day).

At baseline, calcium, phosphorus, zinc, vitamin D, folacin and vitamin E were all below the RNI values for both groups. The calcium, phosphorus and vitamin D intakes were lower than suggested values and this is corroborated by a low intake of dairy products such as milk, cheese and yogurt in both groups. This population is at high risk of osteoporosis and osteomalacia and therefore, the vitamin D and calcium intake should be maintained at or above the suggested values for this age group. The reduced intake of phosphorus could be also exacerbated by the regular consumption of anti-acid or mineral laxatives due to the capacity of these compounds to reduce absorption. Low intake of folacin was also noted which may induce a megaloblastic anemia or an organic brain syndrome characterized by periods of confusion and loss of memory, which are two common symptoms observed in this population. Most other minerals and vitamins were consumed in adequate quantity. The vitamin C content of these dietary intakes was high. They are 2 to 6 times higher than suggested RNIs.

### Comparison of Nutritional Status at 6-Weeks

At the midway evaluation, we could see that the mean energy intake for both groups was now above 6200 kJ (1480 kCal). The treated group had an intake of 8105±2050 kJ (1937±490 kCal) whereas the control group received 6223±2116 kJ (1487±506 kCal). The treated group presented a higher energy intake and the change in intake was statistically different when compared to baseline (Table 10).

Six weeks after the beginning of the protocol, the control group had a macronutrient intake of 15% of energy from proteins, 57% from carbohydrates and 28% from lipids which was similar to the original values. The treated groups showed a slightly different picture. In fact, 17% of the energy was provided by proteins, 56% by carbohydrates and 27% by lipids. At six weeks, the protein intake was significantly higher in the treated group than the intake of the control group (Table 10). No other macronutrient showed a noticeable augmentation. Both diets remained well balanced.

When comparing the intake of the two groups after 6 weeks, potassium, magnesium, calcium, phosphorus, zinc and vitamins B₂, B₃, B₆, B₁₂ and vitamin E where higher in the treated group. SAH's diet provided individuals with an increased quantity of milk and enriched milk, reshaped pureed cakes, reshaped purred vegetables and reshaped pureed meats. This new diet composition coincides with foods providing the micronutrients that demonstrated an increase.

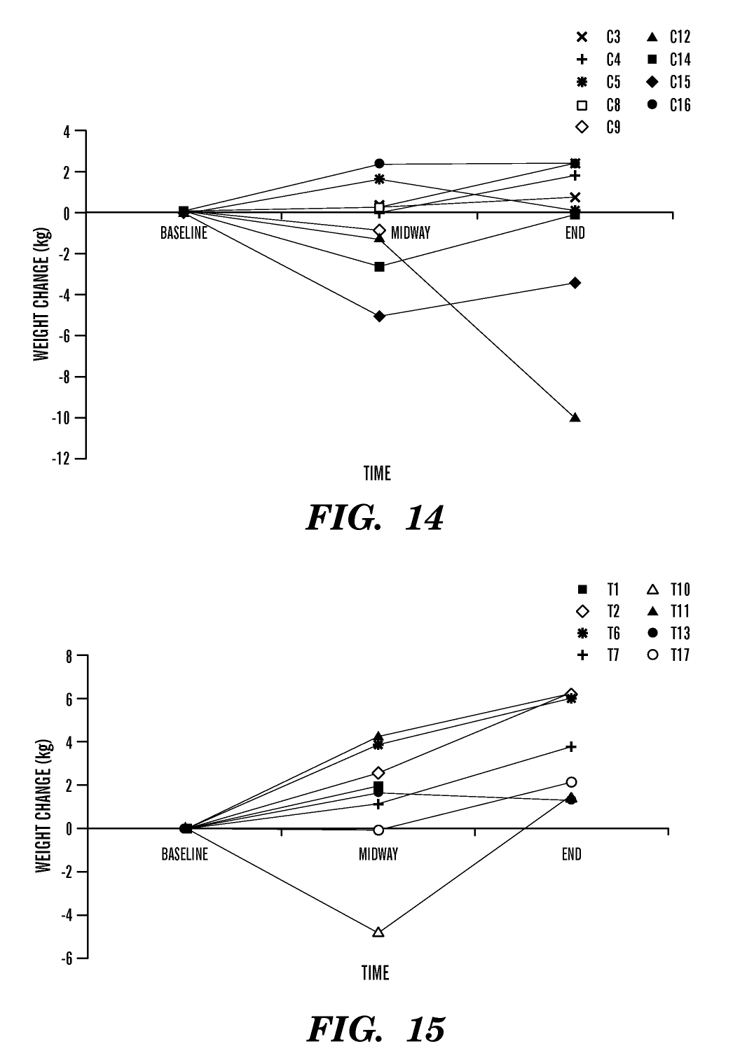

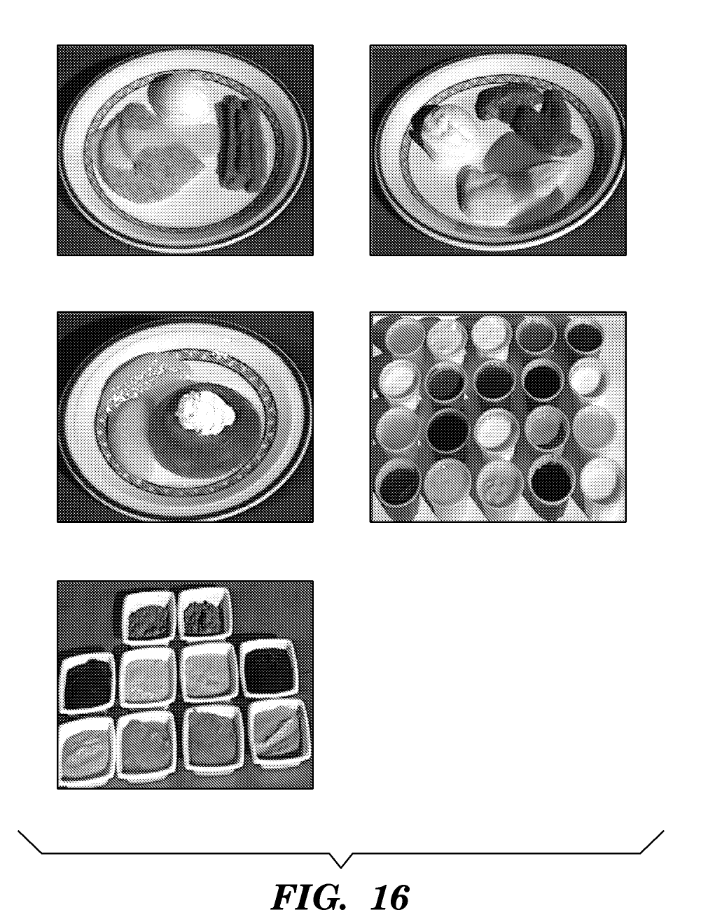

The average change in weight for the control group was −0.61±2.23 kg whereas the experimental group demonstrated a weight change of 1.31±2.85 kg (Table 11). Although the FIG. 14 shows a trend toward an increase for the treated group, the weight changes observed in both groups (FIGS. 14 and 15) were not significantly different at week 6 (p<0.14).

TABLE 10
Energy Intake and Nutrient Composition of the Groups
at the Midway Assessment

| | | | Treated Group | | |
|---|---|---|---|---|---|
| | Control (n = 9) | | (n = 8) | | t-test |
| Variables | Mean | SD | Mean | SD | P-Value |
| Weight (kg) | 53.71 | 8.23 | 57.24 | 10.73 | 0.4559 |
| Number of Prescriptions | 5.67 | 3.12 | 7.63 | 4.50 | 0.3092 |
| BMI | 20.92 | 2.40 | 22.97 | 3.61 | 0.1832 |
| Energy (kJ) | 6223 | 2116 | 8105 | 2050 | 0.0831 |
| Protein (g) | 54.75 | 23.73 | 84.43 | 26.34 | 0.0273 |
| | (15%) | | (17%) | | |
| Carbohydrate (g) | 222.09 | 65.98 | 274.84 | 68.23 | 0.1262 |
| | (57%) | | (56%) | | |
| Lipid (g) | 45.91 | 24.77 | 59.14 | 15.60 | 0.2140 |
| | (28%) | | (27%) | | |
| Cholesterol (mg) | 124.56 | 88.72 | 190.63 | 71.00 | 0.1137 |
| Total Fiber (g) | 17.62 | 9.97 | 10.75 | 4.27 | 0.0864 |
| Sodium (mg) | 2474.72 | 974.07 | 3338.44 | 1396.44 | 0.1560 |
| Potassium (mg) | 2725.72 | 861.41 | 3885.00 | 1141.71 | 0.0310 |
| Magnesium (mg) | 254.89 | 120.94 | 376.50 | 112.30 | 0.0493 |
| Calcium (mg) | 700.94 | 287.22 | 1331.19 | 670.99 | 0.0353 |
| Phosphorus (mg) | 1087.33 | 368.92 | 1650.63 | 606.41 | 0.0331 |
| Iron (mg) | 13.63 | 7.26 | 15.41 | 4.93 | 0.5667 |
| Zinc (mg) | 8.72 | 5.96 | 14.47 | 4.97 | 0.0486 |
| Carotene (RE) | 124.17 | 113.51 | 322.19 | 349.14 | 0.1623 |
| Vitamin A (RE) | 1198.67 | 672.07 | 1716.25 | 611.32 | 0.1191 |
| Vitamin C (mg) | 161.94 | 67.96 | 173.94 | 43.20 | 0.6751 |
| Vitamin D (μg) | 4.73 | 2.36 | 8.89 | 5.85 | 0.0930 |
| Vitamin B₁ (mg) | 1.56 | 1.00 | 2.00 | 0.77 | 0.3344 |
| Vitamin B₂ (mg) | 1.73 | 0.84 | 2.91 | 1.24 | 0.0345 |
| Vitamin B₃ (NE) | 22.36 | 11.47 | 37.38 | 12.53 | 0.0209 |
| Vitamin B₆ (mg) | 1.26 | 0.65 | 2.68 | 0.85 | 0.0014 |
| Vitamin B₁₂ (μg) | 3.08 | 2.06 | 6.23 | 2.23 | 0.0084 |
| Pantothenic Acid (mg) | 4.56 | 3.33 | 5.56 | 2.25 | 0.4832 |
| Folacin (μg) | 202.64 | 141.38 | 297.56 | 87.39 | 0.1223 |
| Total Saturated Fat (g) | 9.37 | 6.00 | 17.99 | 6.66 | 0.0132 |
| Monounsaturated Fat (g) | 9.21 | 6.39 | 18.37 | 6.21 | 0.0092 |
| Polyunsaturated Fat (g) | 4.85 | 3.54 | 7.77 | 2.78 | 0.0808 |
| Vitamin E (mg) | 1.78 | 0.75 | 6.64 | 4.87 | 0.0258 |
| Copper (mg) | 0.92 | 0.49 | 1.15 | 0.53 | 0.3594 |
| Manganese (mg) | 3.22 | 2.12 | 2.75 | 1.25 | 0.5913 |

TABLE 11
Change in the Energy Intake and Nutrient Composition of the Groups
(Baseline vs Midway Assessment)

| | Control (n = 9) | | Treated (n = 8) | | t-test |
|---|---|---|---|---|---|
| Variables | Mean | SD | Mean | SD | p-Values |
| Weight (kg) | −0.61 | 2.23 | 1.31 | 2.85 | 0.1396 |
| BMI | −0.29 | 0.97 | 0.57 | 1.12 | 0.1147 |
| Energy (kJ) | −329 | 1239 | 2357 | 1794 | 0.0025 |
| Protein (g) | −1.22 | 14.36 | 31.94 | 23.38 | 0.0028 |
| Carbohydrate (g) | −16.24 | 45.07 | 63.78 | 61.96 | 0.0078 |
| Lipid (g) | −1.51 | 12.95 | 19.85 | 14.78 | 0.0062 |
| Cholesterol (mg) | −6.44 | 27.45 | 6744.00 | 65.06 | 0.0150 |
| Total Fiber (g) | 0.70 | 3.98 | −1.88 | 4.98 | 0.2539 |
| Sodium (mg) | −43.83 | 516.92 | 758.25 | 815.48 | 0.0269 |
| Potassium (mg) | −159.33 | 497.81 | 1181.13 | 978.05 | 0.0025 |
| Magnesium (mg) | −0.78 | 78.72 | 136.88 | 106.95 | 0.0081 |
| Calcium (mg) | −56.11 | 187.02 | 692.44 | 454.59 | 0.0018 |
| Phosphorus (mg) | −19.83 | 266.11 | 675.31 | 422.50 | 0.0009 |
| Iron (mg) | 0.16 | 1.83 | 3.26 | 4.16 | 0.0889 |
| Zinc (mg) | −0.17 | 6.43 | 6.57 | 5.40 | 0.0348 |
| Carotene (RE) | −12.17 | 124.14 | 155.38 | 336.47 | 0.2174 |
| Vitamin A (RE) | 48.44 | 462.60 | 377.56 | 400.21 | 0.1400 |
| Vitamin C (mg) | 6.67 | 46.46 | 37.50 | 48.92 | 0.2026 |
| Vitamin D (μg) | 0.28 | 2.44 | 5.50 | 4.02 | 0.0050 |
| Vitamin B₁ (mg) | −0.07 | 0.40 | 0.61 | 0.55 | 0.0101 |
| Vitamin B₂ (mg) | −0.20 | 1.39 | 1.53 | 0.87 | 0.0085 |
| Vitamin B₃ (NE) | 0.05 | 7.33 | 14.46 | 12.11 | 0.0089 |
| Vitamin B₆ (mg) | −0.11 | 0.54 | 1.15 | 1.01 | 0.0052 |
| Vitamin B₁₂ (μg) | 0.51 | 1.45 | 3.41 | 2.35 | 0.0071 |
| Pantothenic | 0.03 | 2.24 | 1.76 | 1.82 | 0.1030 |
| Acid (mg) | | | | | |
| Folacin (μg) | 9.75 | 93.02 | 121.90 | 124.17 | 0.0507 |
| Total Saturated | −1.92 | 2.14 | 6.31 | 4.47 | 0.0002 |
| Fat (g) | | | | | |
| Monounsaturated | −1.60 | 2.51 | 5.19 | 5.14 | 0.0070 |
| Fat (g) | | | | | |
| Polyunsaturated | −0.10 | 2.01 | 1.05 | 3.40 | 0.1482 |
| Fat (g) | | | | | |
| Vitamin E (mg) | −0.44 | 1.31 | 5.01 | 4.53 | 0.0110 |
| Copper (mg) | −0.07 | 0.28 | 0.14 | 0.37 | 0.2107 |
| Manganese (mg) | 0.56 | 1.10 | 0.00 | 0.76 | 0.9064 |

TABLE 12
Energy Intake and Nutrient Composition of the Groups
at the Final Assessment

| | | | Treated Group | | |
|---|---|---|---|---|---|
| | Control (n = 8) | | (n = 7) | | t-test |
| Variables | Mean | SD | Mean | SD | P-Value |
| Weight (kg) | 53.40 | 5.87 | 59.93 | 12.99 | 0.2213 |
| Number of | 4.13 | 2.36 | 7.71 | 4.75 | 0.0807 |
| Prescriptions | | | | | |
| BMI | 21.18 | 2.00 | 24.50 | 4.14 | 0.0642 |
| Energy (kJ) | 6708 | 1533 | 8148 | 1324 | 0.0755 |
| Protein (g) | 56.64 | 19.78 | 83.10 | 21.17 | 0.0265 |
| | (14%) | | (17%) | | |
| Carbohydrate (g) | 253.99 | 66.83 | 272.48 | 44.46 | 0.5458 |
| | (63%) | | (56%) | | |
| Lipid (g) | 43.34 | 11.05 | 62.29 | 11.19 | 0.0058 |
| | (24%) | | (29%) | | |
| Cholesterol (mg) | 165.44 | 119.67 | 208.71 | 97.91 | 0.4614 |
| Total Fiber (g) | 16.15 | 4.57 | 12.16 | 4.01 | 0.0980 |
| Sodium (mg) | 2780.88 | 926.73 | 3270.21 | 915.41 | 0.3236 |
| Potassium (mg) | 3094.56 | 688.84 | 3912.93 | 664.74 | 0.0364 |
| Magnesium (mg) | 252.69 | 74.06 | 365.93 | 92.16 | 0.0204 |
| Calcium (mg) | 865.06 | 256.90 | 1347.07 | 643.81 | 0.1024 |
| Phosphorus (mg) | 114.63 | 270.05 | 1640.07 | 450.36 | 0.0345 |
| Iron (mg) | 13.93 | 3.95 | 15.60 | 4.34 | 0.4491 |
| Zinc (mg) | 7.69 | 3.44 | 14.62 | 4.42 | 0.0047 |
| Carotene (RE) | 137.75 | 93.33 | 292.50 | 309.46 | 0.2438 |
| Vitamin A (RE) | 1258.19 | 427.23 | 1516.71 | 543.79 | 0.3214 |
| Vitamin C (mg) | 182.31 | 76.06 | 174.79 | 44.41 | 0.8223 |
| Vitamin D (μg) | 5.19 | 2.01 | 10.13 | 5.35 | 0.0526 |
| Vitamin B₁ (mg) | 1.54 | 0.40 | 1.92 | 0.68 | 0.1982 |
| Vitamin B₂ (mg) | 1.78 | 0.56 | 3.00 | 1.22 | 0.0248 |
| Vitamin B₃ (NE) | 22.24 | 8.01 | 36.22 | 10.91 | 0.0135 |
| Vitamin B₆ (mg) | 1.40 | 0.51 | 2.50 | 0.81 | 0.0070 |
| Vitamin B₁₂ (μg) | 2.80 | 1.53 | 6.12 | 1.82 | 0.0020 |
| Pantothenic Acid (mg) | 4.66 | 1.35 | 5.79 | 2.08 | 0.2308 |
| Folacin (μg) | 203.91 | 66.55 | 295.03 | 103.50 | 0.0604 |
| Total Saturated Fat (g) | 10.85 | 6.21 | 19.04 | 2.76 | 0.0068 |
| Monounsaturated | 9.75 | 6.64 | 20.09 | 5.39 | 0.0060 |
| Fat (g) | | | | | |
| Polyunsaturated | 5.27 | 4.45 | 8.51 | 2.64 | 0.1164 |
| Fat (g) | | | | | |
| Vitamin E (mg) | 2.70 | 1.58 | 5.89 | 4.70 | 0.1291 |
| Copper (mg) | 1.01 | 0.33 | 1.18 | 0.30 | 0.3136 |
| Manganese (mg) | 2.94 | 1.40 | 2.71 | 0.81 | 0.7172 |

TABLE 13
Change in the Energy Intake and Nutrient Composition of the Groups
(Baseline vs End Assessment)

| | Control (n = 8) | | Treated (n = 7) | | t-test |
|---|---|---|---|---|---|
| Variables | Mean | SD | Mean | SD | p-Values |
| Weight (kg) | −0.79 | 4.18 | 3.90 | 2.30 | 0.0208 |
| BMI | −0.27 | 1.46 | 1.63 | 1.01 | 0.0127 |
| Energy (kJ) | 340 | 707 | 2556 | 1709 | 0.0252 |
| Protein (g) | 2.14 | 10.01 | 28.60 | 25.96 | 0.0366 |
| Carbohydrate (g) | 18.08 | 32.29 | 59.26 | 51.09 | 0.0808 |
| Lipid (g) | −0.75 | 7.34 | 21.10 | 18.38 | 0.0195 |
| Cholesterol (mg) | 26.31 | 64.68 | 76.14 | 107.01 | 0.2875 |
| Total Fiber (g) | 1.19 | 2.53 | 0.61 | 1.95 | 0.6315 |
| Sodium (mg) | 321.56 | 487.96 | 582.50 | 768.38 | 0.4401 |
| Potassium (mg) | 261.25 | 434.81 | 1139.36 | 814.61 | 0.0198 |
| Magnesium (mg) | 5.94 | 53.26 | 111.93 | 110.15 | 0.0306 |
| Calcium (mg) | 107.56 | 160.72 | 674.43 | 479.95 | 0.0199 |
| Phosphorus (mg) | 100.06 | 186.89 | 628.07 | 409.78 | 0.0059 |
| Iron (mg) | 1.76 | 1.92 | 3.27 | 3.97 | 0.3557 |
| Zinc (mg) | −0.83 | 3.50 | 5.93 | 4.65 | 0.0069 |
| Carotene (RE) | −5.88 | 106.51 | 110.14 | 194.67 | 0.1682 |
| Vitamin A (RE) | 149.94 | 498.54 | 168.86 | 411.68 | 0.9379 |
| Vitamin C (mg) | 38.06 | 53.68 | 38.36 | 62.07 | 0.9923 |
| Vitamin D (μg) | 0.71 | 1.93 | 6.48 | 3.97 | 0.0029 |
| Vitamin B₁ (mg) | 0.12 | 0.27 | 0.48 | 0.73 | 0.2586 |
| Vitamin B₂ (mg) | −0.16 | 0.79 | 1.54 | 0.86 | 0.0015 |
| Vitamin B₃ (NE) | 0.99 | 3.80 | 11.69 | 12.39 | 0.0642 |
| Vitamin B₆ (mg) | 0.06 | 0.46 | 0.84 | 1.03 | 0.0729 |
| Vitamin B₁₂ (μg) | 0.28 | 0.77 | 2.98 | 2.37 | 0.0229 |
| Pantothenic Acid (mg) | 0.51 | 1.22 | 1.69 | 1.92 | 0.1708 |
| Folacin (μg) | 25.97 | 54.91 | 103.06 | 127.58 | 0.1768 |
| Total Saturated Fat (g) | −1.18 | 2.70 | 5.99 | 3.71 | 0.0008 |
| Monounsaturated | −1.75 | 3.32 | 5.18 | 5.58 | 0.0109 |
| Fat (g) | | | | | |
| Polyunsaturated | −0.92 | 2.97 | 0.91 | 4.26 | 0.3460 |
| Fat (g) | | | | | |
| Vitamin E (mg) | 0.65 | 1.56 | 4.16 | 4.11 | 0.0684 |
| Copper (mg) | 0.09 | 0.22 | 0.10 | 0.35 | 0.9342 |
| Manganese (mg) | 0.65 | 1.56 | 4.16 | 4.11 | 0.0684 |

patients had to be completely taken care of during the total meal period. Therefore, the orderly had to prepare the meal, stimulate verbally and feed the resident. Two patients had to be partially fed or totally fed certain days or meals. No subject could entirely eat on their own.

TABLE 14
Characteristics of the Feeding Approach During Meals

| Control | Base- | | | Treated | | | |
|---|---|---|---|---|---|---|---|
| Group | line | Midway | Final | Group | Baseline | Midway | Final |
| SF | 0 | 0 | 0 | SF | 3 | 2 | 2 |
| FP | 3 | 2 | 2 | FP | 2 | 3 | 2 |
| FP-T | 2 | 2 | 2 | FP-T | 0 | 0 | 1 |
| FT | 4 | 5 | 5 | FT | 3 | 3 | 3 |

SF: Mostly independent for feeding (opening of certain containers might be necessary)
FP: Partially dependent for feeding (opening of containers. verbal stimulation needed)
FP-T: Partially or totally dependent for feeding (will vary according to patients health status)
FT: Totally dependent for feeding

The treated group had 3 subjects that could eat on their own once the tray was prepared for them (for example: milk cartons or jam containers opened for them). Two individuals were partially helped during the meals and 3 patients had to be completely taken care of during the total meal period. Most subjects were receiving their meals in the dining room of the ward or in their room. One individual in the treated group was well enough to receive his lunch and dinner meals at the cafeteria on the main floor of MR Center.

At the midway evaluation, 1 control subject had lost some abilities and was now fed with complete help. The treated group had only 2 subjects who could self-feed by that time. Most subjects were still receiving their meals in the dining room of the ward or in their room and 1 individual in the treated group remained well enough to receive his lunch and dinner meals at the cafeteria.

The final evaluation showed no change in the way individuals of the control group were being fed. On the other hand, the treated group had only 2 subjects who could partially fed themselves at that point in time. Two individuals were now partially or totally dependent on the orderly for feeding. No statistical difference could be established.

Time necessary to feed the subjects under evaluation at baseline is presented in Table 15. Length of the average meal required a minimum of 22 minutes (Range for control group: 10 to 40 min. and range for treated group: 10 to 50 min.) We can observe that the treated group seems to be slower for the feeding process but due to high variability, the difference is not statistically significant for any of the meals. This considerable variability can be explained by each patient varying alertness and health status at each meal (fatigue, side effects of medications such as drowsiness and sleepiness, overall health of the moment) and/or the rhythm and the personality of the feeder taking care of the individual.

Recording the time required to feed the individuals was used to evaluate if the increase in total energy intake was associated to a longer meal period. It appears that the change in length of time was not significant in either group. We could therefore say that the increase in total energy obtained in the treated group was not achieved at the expense of a longer feeding time.

### Variety of Food Choices

Although the number of food servings per food group did not change significantly by the end of the trial (Table 16) when both groups are compared, it is possible to notice that the food choices (Tables 17a and 17b) were different between both groups. The menu provided by SAH was designed with respect to the regular texture menu and considered the choices of meat and vegetable available on any given day. The puree diet and the minced diet offered an extensive choice and permitted many permutations varying the meats and the vegetables as needed. The CAMPBELL® TREPUREE™ were pre-established combination of dishes and offered reduced versatility.

TABLE 15
Time Required to Feed

| | Baseline Values - Feeding Time | | | | |
|---|---|---|---|---|---|
| | Control | | Treated Group | | |
| | (n = 9) | | (n = 8) | | T-test |
| Variables | Mean | SD | Mean | SD | P-Value |
| Time for Breakfast (min.) | 28.56 | 25.14 | 31.19 | 24.39 | 0.7594 |
| Time for Lunch (min.) | 25.00 | 14.15 | 32.81 | 15.06 | 0.1288 |
| Time for Supper (min.) | 22.78 | 7.92 | 32.06 | 17.71 | 0.0675 |
| | Change in Feeding Time | | | | |
| | (Baseline vs Midway) | | | | |
| | Control | | Treated | | |
| | (n = 9) | | (n = 8) | | |
| Variables | Mean | SD | Mean | SD | P-Value |
| Time for Breakfast (min.) | −1.89 | 22.73 | 8.13 | 13.84 | 0.1366 |
| Time for Lunch (min.) | 4.83 | 18.83 | 8.06 | 15.64 | 0.5930 |
| Time for Supper (min.) | 3.78 | 16.23 | 1.00 | 18.99 | 0.6487 |
| | Change in Feeding Time (Baseline vs End) | | | | |
| | Control | | Treated | | |
| | (n = 8) | | (n = 7) | | |
| Variables | Mean | SD | Mean | SD | P-Value |
| Time for Breakfast (min.) | −5.89 | 17.37 | −5.75 | 23.61 | 0.9844 |
| Time for Lunch (min.) | 1.22 | 17.40 | −2.69 | 21.86 | 0.5659 |
| Time for Supper (min.) | 6.39 | 17.21 | −5.81 | 28.66 | 0.1514 |
| | Change in Feeding Time (Midway vs End) | | | | |
| | Control | | Treated | | |
| | (n = 8) | | (n = 7) | | |
| Variables | Mean | SD | Mean | SD | P-Value |
| Time for Breakfast (min.) | −2.50 | 25.02 | −13.00 | 18.88 | 0.2103 |
| Time for Lunch (min.) | 0.69 | 14.65 | −5.36 | 17.37 | 0.3100 |
| Time for Supper (min.) | 5.50 | 15.33 | −2.79 | 21.35 | 0.2281 |

### CONCLUSION

Malnutrition, and more specifically, protein-energy malnutrition is very common in the institutionalized elderly population. Dysphagia is also an exacerbating factor of malnutrition and is a secondary condition in several degenerative diseases developing with old age.

A 12-week clinical trial using the SAH's reshaped foods and thickened beverages was conducted. All the variables were successfully collected. Our results show a statistically significant change in energy intake and weight using SAH advanced nutritional care with a group of 8 treated individuals compared to 9 controls. Since the implementation of SAH's nutritional approach was meant to increase variety of foods, augment high-density foods and maintain a well balanced diet, these changes confirmed the expected results of the application of SAH's approach. Furthermore, all the established parameters were readily obtained during the clinical trial. The SAH's reshaped foods were successful in providing appealing texture modified foods to the elderly dysphagic clientele.

TABLE 16
Averaged Number of Portions Consumed per
Food Group at Final Assessment

| | Treated Group | | | Control Group | | | |
|---|---|---|---|---|---|---|---|
| | Av- | | | Av- | | | P- |
| | erage | SD | Range | erage | SD | Range | Values |
| Dairy | 3 | 2.24 | 0-6.5 | 2.83 | 2.33 | 0-6 | 0.8868 |
| Products | | | | | | | |
| Vegetables | 3.43 | 1.95 | 0-6 | 1.83 | 1.56 | 0-3.5 | 0.1034 |
| Fruits | 3.71 | 1.98 | 0-6.5 | 4.11 | 2.26 | 0-7 | 0.7141 |
| Meats | 1.21 | 0.7 | 0-2 | 0.67 | 0.66 | 0-1.5 | 0.136 |
| Grains | 1.71 | 0.95 | 0-3 | 1.28 | 0.75 | 0-2 | 0.3407 |
| Combined | 1.43 | 1.43 | 0-3 | 2.44 | 1.31 | 0-4 | 0.168 |
| dishes | | | | | | | |
| Baked | 0.79 | 0.7 | 0-2 | 0.72 | 0.83 | 0-2.5 | 0.8708 |
| Goods | | | | | | | |
| Oil and Fats | 1.21 | 0.91 | 0-3 | 0.44 | 0.53 | 0-1 | 0.0762 |
| Sweets | 1.29 | 0.95 | 0-2.5 | 1.11 | 0.65 | 0-2 | 0.6862 |
| Supplements | 0.93 | 1.24 | 0-3 | 0.61 | 1.05 | 0-3 | 0.5978 |
| Miscellaneous | 3.43 | 1.99 | 0-6 | 2.5 | 2.49 | 0-8 | 0.4206 |

### Table 17

### Menu Selection Specific to SAH

TABLE 17 a

| Dairy Products | Enriched Milk | | | | | |
|---|---|---|---|---|---|---|
| 9 Pureed | Broccoli P/F | | | Asparagus P/F | | |
| Vegetables | Carrots P/F | | | Green beans P/F | | |
| | Cauliflower P/F | | | Lettuce P/F | | |
| | Green Peas P/F | | | Fresh tomato P/F | | |
| | Waxed beans P/F | | | | | |
| 5 Pureed Fruits | Halves of Pear P/F | | | Pineapple slices | | |
| | Slivers of Peach P/F | | | P/F | | |
| | Strawberries P/F | | | Applesauce | | |
| Meats/Main Entrees | Bourguignon Beef | P/F | M/F | Beef slices | P/F | M/F |
| | Fall Stew | P/F | M/F | Chicken Breasts | P/F | M/F |
| 17 Pureed Items | Soukiaki Stew | P/F | M/F | Cold ham slices | P/F | M/F |
| 14 Minced Items | Stroganoff Stew | P/F | M/F | Hamburger Steak | P/F | M/F |
| | Vegetable Stew | P/F | M/F | Hot ham slices | P/F | M/F |
| | Meat Pie | P/F | M/F | Lamb cutlet | P/F | M/F |
| | Lasagna | P/F | | Pork cutlet | P/F | M/F |
| | Salmon Pie | P/F | | Turkey slices | P/F | M/F |
| | Shepherd's Pie | P/F | | Veal slices | P/F | M/F |

| | | |
|---|---|---|
| 9 Sweets/Desserts | Carrot cake | Apple cake |
| | Choco-Moka cake | Triffle cake |
| | Oatmeal cookies | Black Forest cake |
| | Peach cake | Chocolate cake |
| | Vanilla cake | |
| 7 Supplements | Banana (liquid) | Butterscotch (pudding) |
| | Chocolate (liquid) | Chocolate |
| | Strawberry (liquid) | (pudding) |
| | Vanilla (liquid) | Vanilla (pudding) |

P/F: Pureed Formed
M/F: Minced Formed

TABLE 17b
Menu Selection Specific to MR

| | | |
|---|---|---|
| 6 Pureed Vegetables | Carrots | Carrot and Turnip |
| | Green beans | Mixed vegetables |
| | Green Peas | |
| | Waxed beans | |
| 5 Pureed Fruits | Fruit cocktail sauce | Pineapple sauce |
| | Peach sauce | Apple sauce |
| | Pear sauce | |
| Meats/Main Entrees | When the main dish | Campbell TrePuree |
| 11 Pureed Items | could not be served | Coriander Pork |
| 4 Minced/Soft Items | Minced/Soft Substitutes | Honey Mustard Ham |
| | Hamburger Steak | Lemoned Chicken |
| | Minced Beef | Old Fashion Beef |
| | Minced Pork | Roast Beef |
| | Minced Turkey | Roast Chicken |
| | | Roast Turkey |
| | | Stroganoff Beef |
| | | Tarragon chicken |
| | | Turkey a la King |
| | | White Fish Newburg |
| Sweets/Desserts | Ice Cream and Puddings | Jell-O |
| 6 Supplements | Chocolate (liquid) | Butterscotch (pudding) |
| | Fieldberries (liquid) | Chocolate (pudding) |
| | Vanilla (liquid) | Vanilla (pudding) |

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1.-16. (canceled)

17. A method for facilitating swallowing of a liquid to adequately hydrate an individual affected with dysphagia to liquids comprising identifying an individual with dysphagia to liquids and administering to the individual affected with dysphagia to liquids a thickened liquid composition with a liquid flow between 13 and 15 cm per 30 seconds when measured using a BOSTWICK™ consistometer at serving temperature.

18. A method for facilitating swallowing of a liquid to adequately hydrate an individual affected with dysphagia to liquids comprising administering to the individual affected with dysphagia to liquids a thickened liquid composition with a liquid flow between 7 and 9 cm per 30 seconds when measured using a BOSTWICK™ consistometer at serving temperature

19. A method for facilitating swallowing of a liquid to adequately hydrate an individual affected with dysphagia to liquids comprising administering to the individual affected with dysphagia to liquids a thickened liquid composition with a liquid flow between 3 and 5 cm per 30 seconds when measured using BOSTWICK™ consistometer at 8° C.
